(19) United States
(12) Patent Application Publication
(10) Pub. No.: US 2011/0019265 A1
(43) Pub. Date: Jan. 27, 2011

(54) DISPLAY ELEMENT AND METHOD OF FORMING POROUS LAYER IN DISPLAY ELEMENT

(76) Inventor: Akihito Hisamitsu, Kanagawa (JP)

Correspondence Address: HOLTZ, HOLTZ, GOODMAN & CHICK PC, 220 Fifth Avenue, 16TH Floor, NEW YORK, NY, 10001-7708, US

(21) Appl. No.: 12/933,690

(22) PCT Filed: Jul. 8, 2009
(86) PCT No.: PCT/JP2009/062435

§ 371 Date: Sep. 21, 2010

(30) Foreign Application Priority Data
Jul. 24, 2008 (JP) 2008-190799

(51) Int. Cl. G02B 26/00; B05D 5/12

(52) U.S. Cl. 359/297; 427/71

(57) ABSTRACT

The present invention can realize bright white display, a high contrast black-white display and full color display with a simple structure of element members, and provide a display element exhibiting high durability and a method of forming a porous layer in the display element. Also disclosed is a display element comprising a porous layer and an electrolyte between a pair of facing electrodes, wherein the porous layer comprises particles bonded to each other by a metal or nonmetal oxide, the metal or nonmetal oxide deposited from a treatment solution comprising a deposition promoter and a complex comprising a metal or nonmetal ion and a ligand via reaction of the ligand with the deposition promoter.

### TECHNICAL WIELD

The present invention relates to a novel electrochemical display element and a method of forming a porous layer in the display element.

### BACKGROUND

Recently, along with enhancement of the operating speed of personal computers, the spread of network infrastructure, and increased and lower-priced mass storage, data of documents or image, which were conventionally printed on paper, can be received simply as electronic information so that opportunities to read such electronic information have dramatically increased.

There were used, as a means for reading electronic information, conventional liquid crystal displays or CRTs and recent emission type displays, such as organic electroluminescence displays. Specifically, when electronic data is document data, it is necessary to notice this reading means over a relatively long period of time. It is hard to say that such an action is a kindly means to humans. There are generally known disadvantages of emission type displays such that flickering tires human eyes, they are awkward to carry about, the reading posture is restricted, it is necessitated to gaze at a stationary picture plane, and electric power consumption increases when reading over a long time.

As a display means to redeem the foregoing disadvantages is known a (memory type) reflective display which employs external light and does not consume electrical power for image retention. However, based on the reasons below, it is hard to say that such displays provide sufficient performance.

For instance, a system using a polarizing plate such as a reflective liquid crystal display exhibits a relatively low reflectance of up to 40%, resulting in difficulty in displaying whiteness and methods of preparing constituent members are not necessarily simple. A polymer dispersed liquid crystal display requires a relatively high voltage and employment of the difference in refractive index between organic compounds does not result in images with sufficient contrast. A polymer networked liquid crystal display has problems such that it requires a relatively high voltage and a complex TFT circuit to enhance memory. An electrophoretic display element needs relatively high voltage of more than 10 V, and there is a concern of durability of the electrophoretic particles, due to their tendency to coagulate.

There are known, as a display system to overcome these disadvantages of the foregoing systems, an electrochromic display element (hereinafter, denoted as EC system), and an electrodeposition (hereinafter, denoted as ED system) system utilizing dissolution and deposition of metals or metal salts. The EC system enabling full color display at a low voltage of not more than 3 V exhibits advantages such as simple cell configuration and excellent while color quality. The ED system, which can be driven at a relatively low voltage of not more than 3 V, also exhibits advantages such as simple cell configuration and being superior in black and white contrast as well as in black color quality. There are disclosed various methods (refer to Patent Documents 1-5, for example).

In these systems, there often appears a case where a porous layer in which particles are aggregated is provided. For example, in order to highly enhance display contrast and white display reflectance, a porous white scattering layer can be provided, but an aqueous mixture of a white pigment and an aqueous polymer substantially insoluble in an electrolyte solvent is coated and dried to form the porous white scattering layer. Further, in the case of the EC system, in order to increase an amount to immobilize an electrochromic dye, provided is a porous electrode layer in which electrically conductive particles formed of TiO₂ or ITO are aggregated on an electrode on the display side to immobilize a dye. However, since the porous layer tends to be peeled off via repetitive operation for a long duration, and via bending or folding, there is a problem such that no interparticle adhesion is sufficient.

On the other hand, known is a technique of liquid-phase-depositing metal oxide via equilibrium reaction in a solution of a metal fluoride complex (refer to Patent Document 6, for example). Since the metal oxide is deposited at room temperature, there appears a feature in which the metal oxide exhibits excellent throwing power of electrolyte coloring, and can be evenly deposited on the surface regardless of shape of the deposited product. However, in this technology, no description and suggestion concerning improvement of durability of the porous layer in the display element is given at all.

### PRIOR ART DOCUMENT

### Patent Document

Patent Document 1: WO No. 2004/068231

Patent Document 2: WO No. 2004/067673

Patent Document 3: U.S. Pat. No. 4,240,716

Patent Document 4: Japanese Patent No. 3428603

Patent Document 5: Japanese Patent Open to Public Inspection (O.P.I.) Publication No. 2003-241227

Patent Document 6: Japanese Patent O.P.I. Publication No. 3-67978

### DISCLOSURE OF THE INVENTION

### Problems to be Solved by the Invention

The present invention was made on the basis of the above-described situation, it is an object of the present invention that bright white display, a high contrast black-white display and full color display can be realized with a simple structure of element members, and provided can be a display element exhibiting high durability and a method of forming a porous layer in the display element.

### Means to Solve the Problems

The above-described object of the present invention is accomplished by the following structures.

(Structure 1) A display element comprising a porous layer and an electrolyte between a pair of facing electrodes, wherein the porous layer comprises particles bonded to each other by a metal or nonmetal oxide, the metal or nonmetal oxide deposited from a treatment solution comprising a deposition promoter and a complex comprising a metal or nonmetal ion and a ligand via reaction of the ligand with the deposition promoter.

(Structure 2) A method of forming a porous layer in a display element comprising the porous layer and an electrolyte between a pair of facing electrodes, comprising the steps of placing particles on at least one of the pair of facing electrodes, immersing the at least one of the pair of facing electrodes on which the particles are placed in a treatment solution comprising a deposition promoter and a complex comprising a metal or nonmetal ion and a ligand to deposit a metal or nonmetal oxide, and bonding the particles to each other to form the porous layer.

(Structure 3) The display element of Structure 1, wherein the electrolyte comprises a metal salt compound to conduct a black display and a white display via driving operation of the pair of facing electrodes.

(Structure 4) The display element of Structure 1, comprising a compound represented by the following Formula (L), provided between the pair of facing electrodes, to conduct a white display and a display other than the white display via driving operation of the pair of facing electrodes:

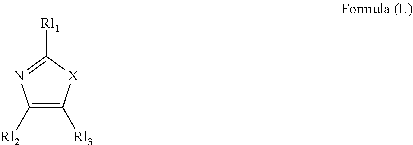

wherein Rl₁ represents a substituted or unsubstituted aryl group; each of Rl₂ and Rl₃ represents a hydrogen atom or a substituent; and X represents >N-Rl₄, an oxygen atom or a sulfur atom, wherein Rl₄ represents a hydrogen atom or a substituent.

(Structure 5) The display element of Structure 3, comprising a compound represented by the Formula (L), provided between the pair of facing electrodes, to conduct a color display other than a black display and a white display in addition to the black display and the white display via driving operation of the pair of facing electrodes.

(Structure 6) The display element of Structure 3 or 5, wherein the metal salt compound comprises a silver salt compound.

(Structure 7) The display element of any one of Structures 1 and 3-6, wherein the electrolyte comprises a compound represented by the following Formula (G-1) or Formula (G-2):

Rg₁₁-S-Rg₁₂ Formula (G-1)

wherein each of Rg₁₁ and Rg₁₂ represents a substituted or unsubstituted hydrocarbon group; the hydrocarbon group may contain at least one selected from the group consisting of a nitrogen atom, an oxygen atom, a sulfur atom, a sulfur atom and a halogen atom; and Rg₁₁ and Rg₁₂ may be connected to each other to form a cyclic structure,

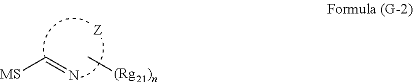

wherein M represents a hydrogen atom, a metal atom or a quaternary ammonium; Z represents an atomic group to constitute a nitrogen-containing heterocyclic ring; n is an integer of 0-5; and Rg₂₁ represents a substituent; and when n is 2 or more, Rg₂₁s each may be the same or different and may also be connected to each other to form a condensed ring.

(Structure 8) The display element of Structure 4 or 5, wherein the compound represented by Formula (L) is chemically or physically adsorbed onto at least a porous electrode.

(Structure 9) The display element of Structure 8, wherein the compound represented by Formula (L) comprises at least one substituent selected from the group consisting of —COOH, —P═O(OH)₂, —OP═O(OH)₂, and —Si(OR)₃ where R represents an alkyl group.

(Structure 10) The display element of any one of Structures 1 and 3-9, wherein the metal or nonmetal oxide deposited from a treatment solution comprises SiO₂ or TiO₂.

(Structure 11) The display element of any one of Structures 1 and 3-10,

wherein the porous layer is electrically conductive.

### EFFECT OF THE INVENTION

In the present invention, bright white display, a high contrast black-white display and full color display can be realized with a simple structure of element members, and provided can be a display element exhibiting high durability and a method of forming a porous layer in the display element.

### DESCRIPTION OF THE PREFERRED EMBODIMENTS

Next, the preferred embodiments of the present invention will be described in detail.

After considerable effort during intensive studies, the inventor has found out that a display element comprising a porous layer and an electrolyte between a pair of facing electrodes, wherein the porous layer comprises particles bonded to each other by a metal or nonmetal oxide, the metal or nonmetal oxide deposited from a treatment solution comprising a deposition promoter and a complex comprising a metal or nonmetal ion and a ligand via reaction of the ligand with the deposition promoter is possible to realize bright white display, a high contrast black-white display and full color display with a simple structure of element members, and the display element exhibiting high durability can be realized with a simple structure of element members, resulting in achievement of the present invention.

Next, the display element of the present invention will be described in detail.

First, a porous layer and constituent elements provided between facing electrodes will be described.

### [Porous Layer]

The display element of the present invention contains a deposited material formed via immersion in a treatment solution containing particles, a complex possessing a metal or nonmetal ion and a ligand, and a deposition promoter by which a metal or nonmetal oxide is deposited from a solution via reaction of the ligand in the complex, and possesses the porous layer in which the particles are bonded to each other by the deposited material.

As to the porous layer applicable for the present invention, a porous layer exhibiting excellent durability can be formed by depositing a metal oxide so as to bond particles to each other via coating and drying of a particle dispersion, and further via immersion with a treatment solution containing a complex possessing a metal or nonmetal ion and a ligand, and a deposition promoter to deposit the metal or nonmetal oxide from a solution via reaction with the ligand in the complex.

The particles of the present invention are particles in fine size, which are usable with no problem, as long as they are made of a material exhibiting no solubility. The particle size is preferably from several nm to several μm, and particles having a size of less than 50 nm are preferable. Examples of such commercially available particles include particles made of metal oxide such as titanium oxide, tin oxide, zinc oxide, aluminum oxide and so forth, particles made of glass, and particles made of a resin such as polymethylmethacrylate or the like. In cases where a porous layer is formed on an electrode on the display side, the layer is desired to be substantially transparent in an electrolytic solution, and employing glass, resin beads, and particles made of tin oxide, zinc oxide, aluminum oxide, titanium oxide and so forth, a thickness of from several nm to several μm is preferably provided. A thickness of 1-10 μm is specifically preferable, and a thickness of 0.25-5 μm is more preferable.

When forming it on an electrode on the nondisplay side, an opaque material is also usable. Specifically when employing titanium oxide and white beads, a white scattering property is possessed by forming it in appropriate thickness, whereby contrast can be increased by improving a white color property of an element. When a white scattering layer is designed to be prepared, a thickness of from several μm to several tens of μm is preferable, and a thickness of approximately 15 μm to 40 μm is specifically preferable.

In the present invention, examples of the ligand used in a treatment solution include F⁻, Cl⁻, ClO4⁻, SO₄²⁻, OSO₄⁻ and so forth, but F⁻ is preferably used since various metal or nonmetal ions and complexes can be formed, and the treatment solution exhibits good stability. The metal or nonmetal ion may be selected from oxide to be deposited and selected from ions of Si, Ti, Sn, Zn, Zr, Nb, V and so forth, and Si and Ti are preferable in view of stability of the deposited material. As the deposition promoter, Al, H₃BO₃ and so forth are preferably used as a deposition promoter, since used may be a material to form a complex or a compound more stable than the ligand in comparison to a metal or nonmetal ion as original raw material. The deposition amount of the deposited material can be adjusted depending on concentration of the treatment solution, temperature, treating time and so forth. Since ionic species contained in an electrolyte is desired to be maintained in a movable state, a material is to be deposited to such an extent that pores are not completely sealed, and a small amount of deposited material is preferable as long as interparticle bonding is maintained. Concentration and temperature of the treatment solution and treating time should be arranged to be set so as to satisfy such a condition, and for example, a concentration of 0.01-1.0 mol/L, a temperature of 5-98° C., and a treating time of approximately 10 seconds-24 hours may be arranged to be set. After completion of the treatment, it is preferred to be sufficiently washed with water or the like.

An aqueous polymer substantially insoluble in an electrolyte solvent may be contained in a dispersion of particles.

As aqueous polymers substantially insoluble in an electrolyte solvent of the present invention, water-soluble polymers and polymers dispersed in an aqueous solvent are listed.

Examples of the water-soluble compound include protein such as gelatin or gelatin derivatives; cellulose derivatives; natural compounds such as polysaccharides like starch, gum arabic, dextran, pullulan, carageenan; and synthetic polymeric compounds such as polyvinyl alcohol, polyvinyl pyrrolidone, acrylamide polymers, and their derivatives. The gelatin derivatives include acetylated gelatin and phthalated gelatin. The polyvinyl alcohol derivatives include terminal alkyl-modified polyvinyl alcohol and terminal mercapto group-modified polyvinyl alcohol. The cellulose derivatives include hydroxyethyl cellulose, hydroxypropyl cellulose, and carboxymethyl cellulose. In addition, there are also usable those described in Research Disclosure and on pages 71-75 of Japanese Patent O.P.I. Publication No. 64-13546; and highly water-absorbing polymers described in U.S. Pat. No. 4,960,681 and Japanese Patent O.P.I. Publication No. 62-245260, that is, including homopolymers of vinyl monomers containing —COOM or —SO₃ M (M is a hydrogen atom or an alkali metal) and copolymers of these monomers or of the same or other monomers (e.g., sodium methacrylate, ammonium methacrylate, and potassium acrylate). These binders can be also used in combination with at least two kinds.

In the present invention, gelatin, a gelatin derivative, polyvinyl alcohol, or a derivative thereof is preferably usable.

Examples of polymers dispersed in an aqueous solvent include latexes such as natural rubber latex, styrene butadiene rubber, butadiene rubber, nitrile rubber, chloroprene rubber and isoprene rubber; and thermosetting resins prepared by dispersing, in an aqueous solvent, polyisocyanate based, epoxy based, acrylic based, silicone based, polyurethane based, urea based, phenol based, formaldehyde based, epoxy-polyamide based, melamine based, alkyd based, or vinyl based resins. Of these polymers, aqueous polyurethane resins described in Japanese Patent O.P.I. Publication No. 10-76621 are preferably used.

The meaning of “being substantially insoluble in an electrolyte solvent” in the present invention is defined as a state where the dissolved amount per kg of an electrolyte solvent is 0-10 g in the temperature range between −20° C. and 120° C. Such a dissolved amount can be determined using any of the methods known in the art such as a mass measurement method or a component quantitative method employing a liquid chromatogram or a gas chromatogram.

In the present invention, an aqueous mixture of an aqueous compound and a white pigment is preferably in a form where the white pigment is dispersed in water using a commonly known dispersion method. The mixture ratio of the aqueous compound/the white pigment is preferably 1-0.01 by volume, and more preferably 0.3-0.05 by volume.

In the present invention, a medium to coat an aqueous mixture of an aqueous compound and particles may be located anywhere if being located on a component between facing electrodes of a display element, but is preferably provided on the surface of at least one of the facing electrodes. Examples of medium providing methods include a coating system; a liquid spray system; a spray system via a gas phase such as a system which ejects liquid droplets employing vibration of a piezoelectric element, e.g., a piezo-system ink-jet head; a BUBBLE JET (registered trademark) ink-jet head which ejects liquid droplets employing a thermal head utilizing bumping; and a spray system which sprays liquid via air or liquid pressure.

As a coating system, appropriately selected can be a commonly known coating system, and examples thereof include an air doctor coater, a blade coater, a rod coater, a knife coater, a squeeze coater, an impregnation coater, a reverse roller coater, a transfer roller coater, a curtain coater, a double roller coater, a slide hopper coater, a gravure coater, a kiss roll coater, a bead coater, a cast coater, a spray coater, a calender coater, and an extrusion coater.

Drying of an aqueous mixture of an aqueous compound and particles provided on a medium may be carried out using any method, provided that water can be evaporated by the method. Examples thereof include heating via a heat source, a heating method using infrared radiation, and a heating method using electromagnetic induction. Further, water evaporation may be carried out under reduced pressure.

In a display element of the present invention, an aqueous compound is desirably cured with a hardener during coating and drying or after drying of the aqueous mixture described above.

Examples of such a hardener used in the present invention include hardeners described in column 41 of U.S. Pat. No. 4,678,739, U.S. Pat. No. 4,791,042, Japanese Patent O.P.I. Publication No. 59-116655, Japanese Patent O.P.I. Publication No. 62-245261, Japanese Patent O.P.I. Publication No. 61-18942, Japanese Patent O.P.I. Publication No. 61-249054, Japanese Patent O.P.I. Publication No. 61-245153, and Japanese Patent O.P.I. Publication No. 4-218044. Further specific examples thereof include aldehyde based hardeners (e.g., formaldehyde), aziridine based hardeners, epoxy based hardeners, vinyl sulfone based hardeners {e.g., N,N′-ethylene-bis(vinylsulfonylacetamido) ethane}, N-methylol based hardeners (e.g., dimethylol urea), boric acid, metaboric acid, and polymer hardeners (compounds described, for example, in Japanese Patent O.P.I. Publication No. 62-234157). When gelatin is used as an aqueous compound, of such hardeners, vinyl sulfone based hardeners and chlorotriazine based hardeners are preferably used singly or in combination. Further, when polyvinyl alcohol is used, boron-containing compounds such as boric acid or metaboric acid are preferably used.

Any of these hardeners is used in the range of 0.001-1 g per 1 g of an aqueous compound, and preferably in the range of 0.005-0.5 g per 1 g of an aqueous compound. Further, to enhance film strength, a heat treatment or humidity adjustment during curing reaction is possible to be carried out.

Next, each electrode constituting facing electrodes will be described.

### [Electrode]

An electrode is usable as each of facing electrode for a display element of the present invention.

### (Transparent Electrode on Display Side)

An electrode of the facing electrodes, which is located on the display side, is preferably a transparent electrode.

Transparent electrodes are not particularly limited as long as they are transparent and electrically conductive. Examples thereof include indium tin oxide (ITO), indium zinc oxide (IZO), fluorine-doped tin oxide (FTO), indium oxide, zinc oxide, platinum, gold, silver rhodium, copper, chromium, carbon, aluminum, silicon, amorphous silicon, and BSO (bismuth silicon oxide).

Further, polythiophene, polypyrrole, polyaniline, polyacetylene, polyparaphenylene, polyselenophenylene, and a modification compound thereof can be used singly or in combination.

The surface resistance value is preferably 100Ω/□ or less, and is more preferably 10Ω/□ or less. The thickness of the transparent electrodes is not particularly limited, but is commonly 0.1-20 μm.

### (Grid Electrode: Auxiliary Electrode)

In the present invention, an auxiliary electrode can be additionally provided to at least one of the facing electrodes.

A material exhibiting lower electrical resistivity than that of the electrode portion as a main portion is preferably used for the auxiliary electrode. Preferably usable examples thereof include metals such as platinum, gold, silver, copper, aluminum, zinc, nickel, titanium, bismuth and so forth, and their alloys.

An auxiliary electrode can be placed between the electrode portion as a main portion and a substrate, or placed on the surface on the opposite side of the substrate of the electrode portion as a main portion. At any rate, the auxiliary electrode may be electrically connected to the electrode portion as an auxiliary electrode.

The arrangement pattern of the auxiliary electrode is not specifically limited, but each pattern in the form of a line, a mesh or a circle is possible to be appropriately formed depending on performance to be desired. When the electrode portion as a main portion is divided into plural parts, divided electrode portions may be connected to each other. However, when the electrode portion as a main portion is provided on a substrate on the display side as a transparent electrode, the auxiliary electrode is desired to be provided in shape as well as in frequency so as not to inhibit visibility of a display element.

As a method of forming an auxiliary electrode, usable is a commonly known method. Examples thereof include patterning via photolithography, a printing method, an inkjet method, electrolytic plating, non-electrolytic plating, and a method of forming a pattern via a developing treatment after a light exposure process by using a silver salt photosensitive material.

The line width and line intervals of the auxiliary electrode may be arbitrary, but the line width should be wider in order to increase conductivity. On the other hand, when an auxiliary electrode is additionally provided to a transparent electrode, an area coverage ratio of the auxiliary electrode observed from the display element observation side is preferably 30% or less, and more preferably 10% or less in view of visibility.

The line width of the auxiliary electrode is 1 μm or more and preferably 100 μm or more, and the line interval is preferably from 50 μm to 1000 μm.

### (Method of Forming Electrode)

A commonly known method is usable for formation of a transparent electrode as well as a metal auxiliary electrode. For example, masked evaporation may be conducted on a substrate by a spattering method, or patterning via photolithography may be performed after forming the entire surface.

Further, an electrode is possible to be formed via electrolytic plating, non-electrolytic plating, printing or an inkjet method.

After forming an electrode pattern possessing a catalyst layer having monomer polymerizing ability on a substrate by an inkjet method, a monomer component which is capable of forming an electrically conductive polymer layer via polymerization with the catalyst is provided to polymerize the monomer component, and further, and further, metal plating of such as silver plating is carried out on the electrically conductive polymer layer to form a metal electrode pattern. Since this employs no photo-resist or a mask pattern, processes can be largely simplified.

When forming an electrode material via a coating system, usable examples include commonly known methods such as a dipping method, a spinner method, a spray method, a roll coater method, a flexography method and a screen printing method and so forth.

The following electrostatic inkjet method among inkjet systems is possible to continuously print precisely with high viscosity liquid, and is preferably employed for formation of a transparent electrode as well as a metal auxiliary electrode of the present invention. The viscosity of ink is preferably 30 mPa·s or more, and more preferably 100 mPa·s or more.

### [Electrostatic Inkjet Method]

In a display element of the present invention, as one of preferred embodiments, at least one of a transparent electrode and a metal auxiliary electrode as a composite electrode is formed with a liquid ejection apparatus equipped with a liquid ejection head possessing a nozzle having an inner diameter of 30 μm or less to eject charged liquid, a supply means to supply a solution into the foregoing nozzle, and an ejection voltage applying means to apply an ejection voltage to the solution in the forgoing nozzle. Further, the electrode is preferably formed with an ejection apparatus equipped with a convex meniscus forming means in such a way that the solution in the foregoing nozzle rises in the form of a projected convex from the nozzle top.

Further, it is also preferable to use a liquid ejection apparatus equipped with an operation control means to control application of driving voltage of driving the convex meniscus and application of ejection voltage by an ejection voltage control means, and this operation control means equipped with the first ejection control section, which conducts application of drive voltage of the meniscus forming means during liquid drop ejection while applying ejection voltage by the foregoing ejection voltage applying means.

Further, it is also a preferable embodiment to use a liquid ejection apparatus equipped with an operation control means, which controls drive of the foregoing convex meniscus forming means and voltage application by an ejection voltage applying means, wherein this operation control means is provided with the second ejection control section, which synchronously performs the solution rising operation by the foregoing convex meniscus forming means and the foregoing ejection voltage application, and the foregoing operation control means is provided with a liquid surface stabilization control section, which performs rising operation of the foregoing solution and operation control to draw the liquid surface at the foregoing nozzle top to the inside after application of the ejection voltage.

It is effective to form an electrode pattern via such an electrostatic inkjet method, since an electrode exhibiting excellent on-demand capability, less generation of waste material in quantity, and excellent dimension accuracy can be prepared.

Next, other constituent elements of the display element will be described.

### [Basic Structure of Display Element]

In a display element of the present invention, there provided a pair of facing electrodes in a display section. A transparent electrode such as an ITO electrode or the like as electrode 1 for one of the facing electrodes located close to the display section is provided, and another electrically conductive electrode as electrode 2 is provided. A porous layer of the present invention and an electrolyte layer are provided between electrode 1 and electrode 2, and white display and black display, white display and display other than white, or white display and color display other than black and white in addition to black display are reversibly changeable by applying a voltage of positive polarity or negative polarity between the facing electrodes.

### [Electrolyte]

As a supporting electrolyte usable in a display element of the present invention, a salt, an acid, or an alkali commonly usable in the field of electrochemistry or batteries can be used.

The salt is not specifically limited, and usable examples thereof include an inorganic ion salt such as an alkali metal salt or an alkaline-earth metal salt; a quaternary ammonium salt; a cyclic quaternary ammonium salt; and a quaternary phosphonium salt.

Specific examples of salts include metal salts such as a Li salt, a Na salt and a K salt having a counter anion, selected from a halogen ion, SCN⁻, ClO₄⁻, BF₄⁻, CF₃SO₃⁻, (CF₃SO₂)₂N⁻, (C₂F₅SO₂)₂N⁻, PF₆⁻, AsF₆⁻, CH₃COO⁻, CH₃(C₆H₄)SO₃⁻, and (C₂F₅SO₂)₃C⁻.

Further, cited is a quaternary ammonium salt having a counter anion, selected from a halogen ion, SCN⁻, ClO₄⁻, BF₄⁻, CF₃SO₃⁻, (CF₃SO₂)₂N⁻, (C₂F₅SO₂)₂N⁻, AsF₆⁻, CH₃COO⁻, CH₃(C₆H₄)SO₃⁻, and (C₂F₅SO₂)₃C⁻. Specific examples thereof include (CH₃)₄NBF₄, (C₂H₅)₄NF₄, (n-C₄H₉)₄NBF₄, (C₂H₅)₄NBr, (C₂H₅)₄NClO₄, (n-C₄H₉)₄NClO₄, CH₃(C₂H₅)₃NBF₄, (CH₃)₂(C₂H₅)₂NBF₄, (CH₃)₄NSO₃CF₃, (C₂H₅)₄NSO₃CF₃, and (n-C₄H₉)₄NSO₃CF₃.

Further, other examples are listed below.

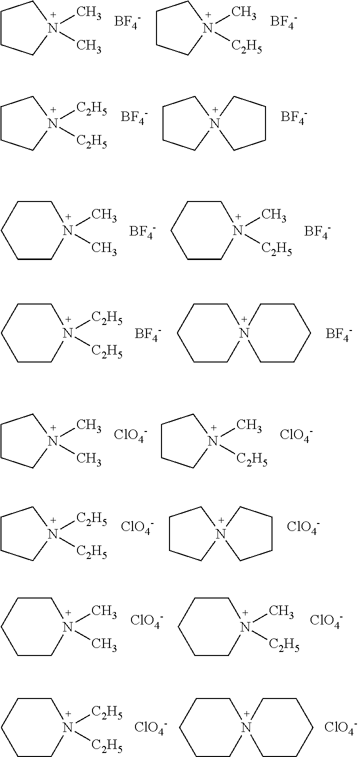

Further, a phosphonium salt having a counter anion, selected from a halogen ion, SCN⁻, ClO₄⁻, BF₄⁻, CF₃SO₃⁻, (CF₃SO₂)₂N⁻, (C₂F₅SO₂)₂N⁻, PF₆⁻, AsF₆⁻, CH₃COO⁻, CH₃(C₆H₄)SO₃⁻, and (C₂F₅SO₂)₃C⁻, and specific examples thereof include (CH₃)₄PBF₄, (C₂H₅)₄PBF₄, (C₃H₇)₄PBF₄, (H₄H₉)₄PBF₄ and so forth. Further, a mixture of these is preferably usable.

As a supporting electrolyte of the present invention, a quaternary ammonium salt is preferable and a quaternary spiroammonium salt is specifically preferable. Further, as a counter anion, ClO₄⁻, BF₄⁻, CF₃SO₃⁻, (C₂F₅SO₂)₂N⁻, and PF₆⁻ are preferable and BF₄⁻ is specifically preferable.

The consumption amount of an electrolyte salt is arbitrary, but the electrolyte salt commonly exists at an upper limit of 20 mol/L or less, preferably at an upper limit of 10 mol/L or less, and more preferably at an upper limit of 5 mol/L or less. The lower limit is commonly 0.01 mol/L or more, preferably 0.05 mol/L or more, and more preferably 0.1 mol/L or more.

Further, a solid electrolyte can contain therein the following compounds exhibiting electronic or ionic conductivity.

Examples thereof include fluorinated vinyl based polymers containing a perfluorosulfonic acid, polythiophene, polyaniline, polypyrrole, triphenylamines, polyvinylcarbazoles, polymethylphenylsilanes, calcogenides such as Cu₂S, Ag₂S, Cu₂Se, and AgCrSe₂, fluorine compounds such as CaF₂, PbF₂, SrF₂, LaF₃, TlSn₂F₅, and CeF₃, lithium salts such as Li₂SO₄ and Li₄SiO₄ and compounds such as ZrO₂, CaO, Cd₂O₃, HfO₂, Y₂O₃, Nb₂O₅, WO₃, Bi₂O₃, AgBr, AgI, CuCl, CuBr, CuBr, CuI, LiI, LiBr, LiCl, LiAlCl₄, LiAlF₄, AgSBr, C₅H₅NHAg₅I₆, Rb₄Cu₁₆I₇Cl₁₃, Rb₃Cu₇Cl₁₀, LiN, Li₅NI₂, and Li₆NBr₃.

### [Metal Salt Compound]

A metal salt compound of the present invention may be any compound, provided that it is a salt containing a kind of metal capable of dissolving and depositing via driving operation of facing electrodes on at least one of the facing electrodes. Examples of preferred kinds of metals include silver, bismuth, copper, nickel, iron, chromium, and zinc. Silver and bismuth are specifically preferable.

### [Silver Salt Compound]

A silver salt compound in the present invention means a generic designation of silver and compounds containing silver in the chemical structure thereof, including, for example, silver oxide, silver sulfide, metal silver, silver colloidal particles, silver halides, silver complex compounds, compounds of silver ion. The phase state species such as a solid state, a solubilization state to liquid, or a gas state and the charging state species such as the neutral, anionic, or cationic state are not specifically taken into account.

In the display element of the present invention, usable are commonly known silver salt compounds such as silver iodide, silver chloride, silver bromide, silver oxide, silver sulfide, silver citrate, silver acetate, silver behenate, silver p-toluenesulfonate, silver trifluoromethanesulfonate, silver salts with a mercapto-compounds, and silver complexes with an iminodiacetic acids. Of these, silver salts of a halogen, a carboxylic acid or a compound not containing a nitrogen atom capable of coordinating with silver are preferred, such as silver p-toluenesulfonate, for example.

The concentration of metal ions contained in an electrolyte of the present invention preferably satisfies the relationship: 0.2 mol/kg≦[Metal]≦2.0 mol/kg. When a metal ion concentration is 0.2 mol/kg or more, a silver solution having sufficient concentration is realized to achieve a desired driving rate. In the case of 2 mol/kg or less, deposition is suppressed, and stability of an electrolytic solution during low temperature storage is enhanced.

### [Concentration Ratio of Halogen Ion to Metal Ion]

In a display element of the present invention, when the molar concentration of halogen ions or halogen atoms contained in an electrolyte is set to [X](mol/kg), and the total molar concentration of silver or silver in a compound containing silver in its chemical structure, contained in the foregoing electrolyte is set to [Metal] (mol/kg), the condition specified by the following Expression (1) is preferably satisfied:

0≦[X]/[Metal]≦0.1 Expression (1)

The halogen atom in the present invention means an iodine atom, a chlorine atom, a bromine atom or a fluorine atom. When [X]/[Metal] is larger than 0.1, the reaction of X⁻→X₂ is induced during redox reaction of a metal and then the X₂ is readily subjected to cross-oxidation with the deposited metal, resulting in dissolution of the deposited metal, which produces one factor to decrease memory capability. Therefore, the molar concentration of a halogen atom is preferably as small as possible, compared to that of metal silver. In the present invention, the relationship of 0≦[X]/[Metal]≦0.001 is more preferable. When halogen ions are added, with regard to the halogen species, the total molar concentration of each of the halogen species preferably satisfies the relationship. [I]<[Br]<[Cl]<[F] from the viewpoint of memory property enhancement.

### [Silver Salt Solvent]

In the present invention, a silver salt solvent is usable to promote dissolution and deposition of a metal salt (specifically silver salt). The silver salt solvent may be any compound as long as it is a compound capable of solubilizing silver in an electrolytic solution. It is common that a means to convert silver or a compound containing silver into a solubilized material by coexisting a compound having a chemical structure kind exhibiting interaction with silver so as to produce a coordinate linkage with silver or a weak covalent bond with silver, for example. As the foregoing chemical structure species, a halogen atom, a mercapto group, a carboxyl group, and an imino group are commonly known, but in the present invention, a compound containing a thioether group and mercaptoazoles effectively act as silver solvents, also exhibiting high solubility to solvents with minimized adverse effects to coexistent compounds.

In the present invention, in order to promote dissolution and deposition of a metal salt (specifically, a silver salt), a compound represented by the following Formula (G-1) or Formula (G-2) is preferably contained.

### {Compound Represented by Formula (G-1) and Compound Represented by Formula (G-2)}

In the electrochemical display element of the present invention, an electrolyte preferably contains at least one of compounds represented by the following Formula (G-1) and Formula (G-2). Compounds represented by Formula (G-1) and Formula (G-2) are compounds capable of promoting solubilisation of silver in an electrolyte since dissolution and deposition of silver are induced in the present invention.

Generally, to allow silver to be dissolved and deposited, silver is desired to be solubilized in an electrolyte. For example, useful is a compound containing chemical structure species exhibiting interaction with silver to produce a coordination bond or a loose covalent bond to silver. As the foregoing chemical structure species, a halogen atom, a mercapto group, a carboxyl group, and an imino group are commonly known, but in the present invention, a compound containing a thioether group and mercaptoazoles effectively act as silver solvents, also exhibiting high solubility to solvents with minimized adverse effects to coexistent compounds.

In foregoing Formula (G-1), each of Rg₁₁ and Rg₁₂ represents a substituted or unsubstituted hydrocarbon group. Further, such a hydrocarbon group may contain at least one selected from the group consisting of a nitrogen atom, an oxygen atom, a sulfur atom, a sulfur atom and a halogen atom; and Rg₁₁ and Rg₁₂ may be connected to each other to form a cyclic structure.

In foregoing Formula (G-2), M represents a hydrogen atom, a metal atom or a quaternary ammonium; Z represents an atomic group to constitute a nitrogen-containing heterocyclic ring; n is an integer of 0-5; and Rg₂₁ represents a substituent; and when n is 2 or more, Rg₂₁s each may be the same or different and may also be connected to each other to form a condensed ring.

In foregoing Formula (G-1), each of Rg₁₁ and Rg₁₂ represents a substituted or unsubstituted hydrocarbon group, but such a hydrocarbon group may contain at least one selected from the group consisting of a nitrogen atom, an oxygen atom, a phosphorous atom, and a sulfur atom; and Rg₁₁ and Rg₁₂ may be connected to each other to form a cyclic structure.

Groups which are possible to be substituted by a hydrocarbon group thereof include an amino group, a guanidino group, a quaternary ammonium group, a hydroxyl group, a halogen compound, a carboxylic acid group, a carboxylate group, an amide group, a sulfinic acid group, a sulfonic acid group, a sulfate group, a phosphonic acid group, a phosphate group, a nitro group, a cyano group and so forth.

Specific examples of the compound represented by Formula (G-1) in the present invention are shown below, but the present invention is not limited to these exemplified compounds.

### G1-1: CH₃SCH₂CH₂OH

### G1-2: HOCH₂CH₂SCH₂CH₂OH

### G1-3: HOCH₂CH₂SCH₂CH₂SCH₂CH₂OH

### G1-4: HOCH₂CH₂SCH₂CH₂SCH₂CH₂SCH₂CH₂OH

G1-5: HOCH₂CH₂SCH₂CH₂OCH₂CH₂OCH₂CH₂SCH₂CH₂OH
G1-6: HOCH₂CH₂OCH₂CH₂SCH₂CH₂SCH₂CH₂OCH₂CH₂OH

### G1-7: H₃CSCH₂CH₂COOH

### G1-8: HOOCCH₂SCH₂COOH

### G1-9: HOOCCH₂CH₂SCH₂CH₂COOH

### G1-10: HOOCCH₂SCH₂CH₂SCH₂COOH

### G1-11: HOOCCH₂SCH₂CH₂SCH₂CH₂SCH₂CH₂SCH₂COOH

G1-12: HOOCCH₂CH₂SCH₂CH₂SCH₂CH(OH)CH₂SCH₂CH₂SCH₂CH₂COOH

G1-13: HOOCCH₂CH₂SCH₂CH₂SCH₂CH(OH)CH(OH)CH₂SCH₂CH₂SCH₂CH₂COOH

### G1-14: H₃CSCH₂CH₂CH₂NH₂

### G1-15: H₂NCH₂CH₂SCH₂CH₂NH₂

### G1-16: H₂NCH₂CH₂SCH₂CH₂SCH₂CH₂NH₂

### G1-17: H₃CSCH₂CH₂CH(NH₂)COOH

G1-18: H₂NCH₂CH₂OCH₂CH₂SCH₂CH₂SCH₂CH₂OCH₂CH₂NH₂
G1-19: H₂NCH₂CH₂SCH₂CH₂OCH₂CH₂OCH₂CH₂SCH₂CH₂NH₂
G1-20: H₂NCH₂CH₂SCH₂CH₂SCH₂CH₂SCH₂CH₂SCH₂CH₂NH₂

### G1-21: HOOC(NH₂)CHCH₂CH₂SCH₂CH₂SCH₂CH₂CH(NH₂)COOH

G1-22: HOOC(NH₂)CHCH₂SCH₂CH₂OCH₂CH₂OCH₂CH₂SCH₂CH(NH₂)COOH
G1-23: HOOC(NH₂)CHCH₂OCH₂CH₂SCH₂CH₂SCH₂CH₂OCH₂CH(NH₂)COOH
G1-24: H₂N(═O)CCH₂SCH₂CH₂OCH₂CH₂OCH₂CH₂SCH₂C(═O)NH₂

### G1-25: H₂N(O═)CCH₂SCH₂CH₂SCH₂C(O═)NH₂

### G1-26: H₂NHN(O═)CCH₂SCH₂CH₂SCH₂C(═O)NHNH₂

### G1-27: H₃C(O═)NHCH₂CH₂SCH₂CH₂SCH₂CH₂NHC(O═)CH₃

G1-28: H₂NO₂SCH₂CH₂SCH₂CH₂SCH₂CH₂SO₂NH₂
G1-29: NaO₃SCH₂CH₂CH₂SCH₂CH₂SCH₂CH₂CH₂SO₃Na
G1-30: H₃CSO₂NHCH₂CH₂SCH₂CH₂SCH₂CH₂NHO₂SCH₃

### G1-31: H₂N(NH)CSCH₂CH₂SC(NH)NH₂.2HBr

### G1-32: H₂(NH)CSCH₂CH₂OCH₂CH₂OCH₂CH₂SC(NH)NH₂.2HCl

### G1-33: H₂N(NH)CNHCH₂CH₂SCH₂CH₂SCH₂CH₂NHC(NH)NH₂.2HBr

### G1-34: [(CH₃)₃NCH₂CH₂SCH₂CH₂SCH₂CH₂N(CH₃)₃]²⁺.2Cl⁻

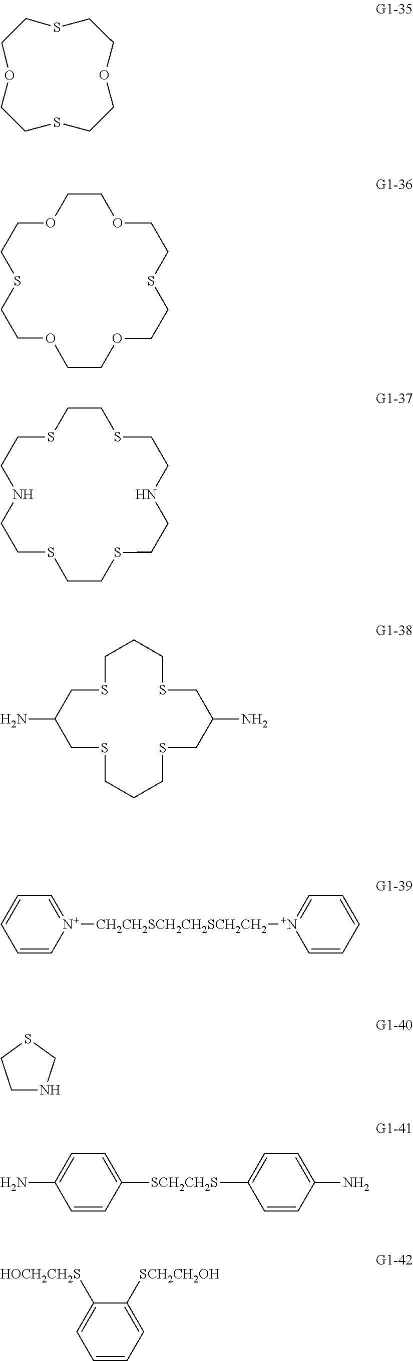

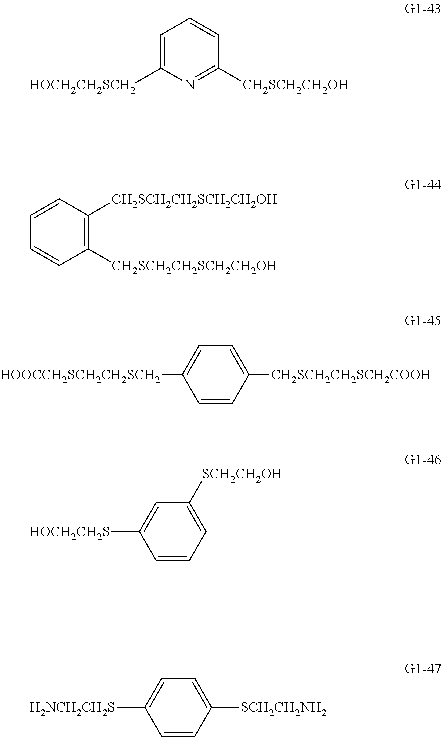

Of the above-exemplified compounds, exemplified compound G1-2 is specifically preferable from the viewpoint of sufficiently producing the intended target effect of the present invention.

Next, the compound represented by Formula (G-2) in the present invention will be described.

In forgoing Formula (G-2), M represents a hydrogen atom, a metal atom or a quaternary ammonium; Z represents an atomic group to constitute a nitrogen-containing heterocyclic ring; n is an integer of 0-5; and Rg₂₁ represents a substituent, and when n is 2 or more, each Rg₂₁ may be the same or different and may be connected to each other to form a condensed ring.

Examples of a metal atom represented by M in Formula (G-2) include Li, Na, K, Mg, Ca, Zn and Ag. Examples of a quaternary ammonium include NH₄, N(CH₃)₄, N(C₄H₉)₄, N(CH₃)₃C₁₂H₂₅ and N(CH₃)₃CH₂C₆H₅.

Examples of a nitrogen-containing heterocyclic ring having Z in Formula (G-2) as a constituting component include a tetrazole ring, a triazole ring, an imidazole ring, an oxazole ring, a thiazole ring, an indole ring, an oxazole ring, a benzoxazole ring, a benzimidazole ring, a benzthiazole ring, a benzoselenazole ring and a naphthoxazole ring.

Substituents represented by Rg₂₁ in Formula (G-2) are not specifically limited, but the following substituents are listed, for example.

Examples of a halogen atom include a fluorine atom, a chlorine atom, a bromine atom and an iodine atom; examples of an alkyl group include a methyl group, an ethyl group, a propyl group, an propyl group, group, a t-butyl group, a pentyl group, a cyclopentyl group, a hexyl group, a cyclohexyl group, an octyl group, a dodecyl group, a hydroxyethyl group, a methoxyethyl group, a trifluoromethyl group and a benzyl group; examples of an aryl group include a phenyl group and a naphthyl group; examples of an alkylcarbonamide group include an acetylamino group, a propionylamino group and a butyloylamino group; examples of an arylcarbonamido group include benzoylamino and so forth; examples of an alkylsulfoneamido group include a methanesulfonylamino group and an ethanesulfonylamino group; examples of an arylsulfoneamido group include a benzenesulfonylamino group and a toluenesulfonylamino group; examples of an aryloxy group include a phenoxy group; examples of an alkylthio group include a methylthio group, an ethylthio group and a butylthio group; examples of an arylthio group include a phenylthio group and a tolylthio group; examples of an alkylcarbamoyl group include a methylcarbamoyl group, a dimethylcarbamoyl group, an ethylcarbamoyl group, a dimethylcarbamoyl group, a dibutylcarbamoyl group, a piperidylcarbamoyl group and a morpholylcarbamoyl group; examples of an anarylcarbamoyl group include a phenylcarbamoyl group, a methylphenylcarbamoyl group, an ethylphenylcarbamoyl group and a benzylphenylcarbamoyl group; examples of an alkylsulfamoyl group include a methylsulfamoyl group, a dimethylsulfamoyl group, an ethylsulfamoyl group, a diethylsulfamoyl group, a dibutylsulfamoyl group, a piperidylsulfamoyl group and a morpholylsulfamoyl group; examples of an arylsulfamoyl group include a phenylsulfamoyl group, a methylphenylsulfamoyl group, an ethylphenylsulfamoyl group and a benzylphenylsulfamoyl group; examples of an allylsulfonyl group include a methanesulfonyl group, and an ethanesulfonyl group; examples of an arylsulfonyl group include a phenylsulfonyl group, a 4-chlorophenylsulfonyl group and a p-toluenesulfonyl group; examples of an alkoxycarbonyl group include a methoxycarbonyl group, an ethoxycarbonyl group, and a butoxycarbonyl group; examples of an aryloxycarbonyl group include a phenoxycarbonyl group and so forth; examples of an alkylcarbonyl group include an acetyl group, a propionyl group and a butyloyl group; examples of an arylcarbonyl group include a benzoyl group and an alkylbenzoyl group; examples of an acyloxy group include an acetyloxy group, a propionyoxy group and a bytyloyloxy group; and examples of a heterocyclic group include groups of an oxazole ring, thiazole ring, triazole ring, selenazole ring, tetrazole ring, oxazole ring, thiadiazole ring, thiazine ring, triazine ring, benzoxazole ring, benzthiazole ring, indolenine ring, benzoselenazole ring, naphthothiazole ring, triazaindolidine ring diazaindolidine ring and tetrazaindolidine. These substituents include those further having a substituent.

Next, preferable examples of the compound represented by Formula (G-2) are shown, but the present invention is not limited thereto.

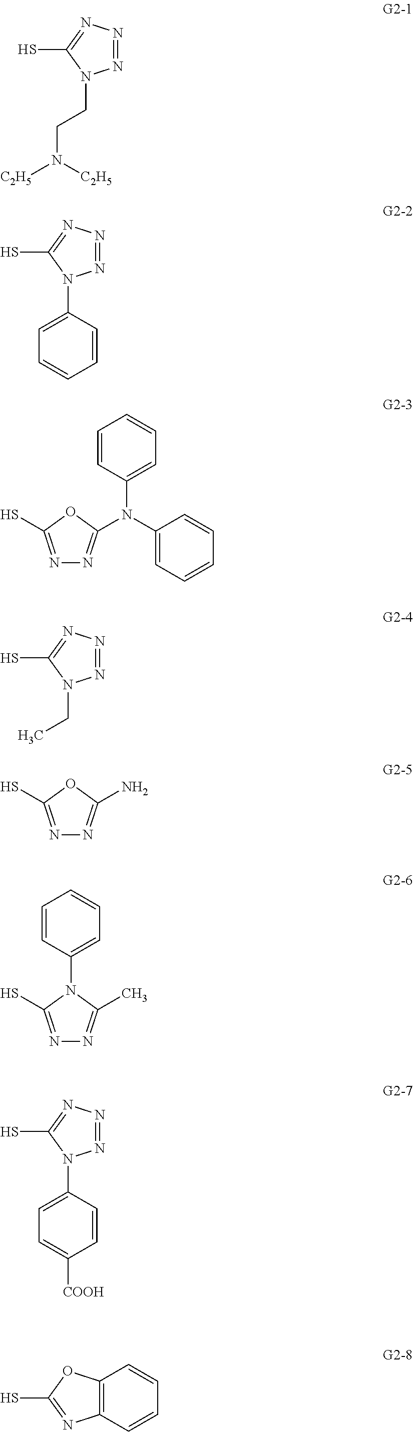

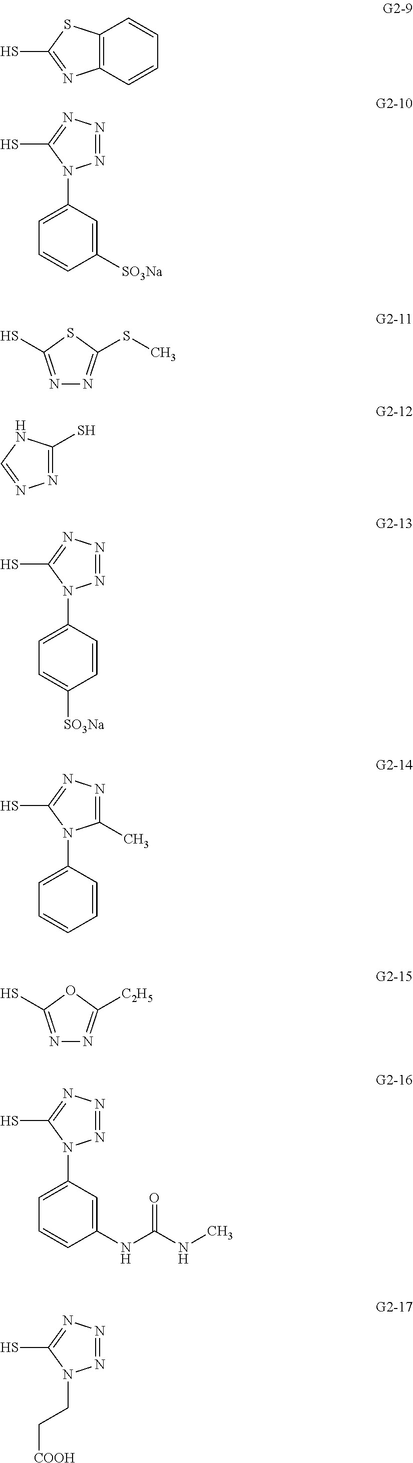

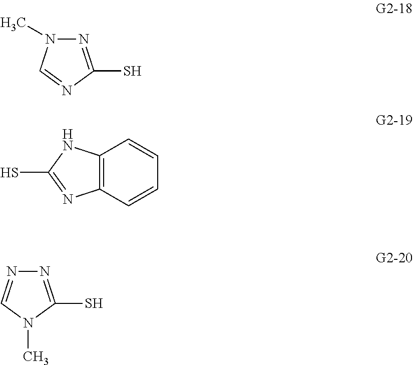

Of the above-exemplified compounds, exemplified compounds G2-12, G2-18 and G2-20 are specifically preferable from the viewpoint of sufficiently producing the intended target effect of the present invention.

[Thickener Added into Electrolyte]

In the display element of the present invention, thickeners can be used for the electrolyte. Examples thereof include gelatin, gum Arabic, poly(vinyl alcohol), hydroxyethyl cellulose, hydroxypropyl cellulose, cellulose acetate, cellulose acetate butyrate, poly(vinylpyrrolidone), poly(alkylene glycol), casein, starch, poly(acrylic acid), poly(methylmethacrylic acid), poly(vinyl chloride), poly(methacrylic acid), copoly(styrene-maleic anhydride), copoly(styrene-acrylonitrile), copoly(styrene-butadiene), poly(vinyl acetals) (for example, poly(vinyl formal), poly(vinyl butyral), poly(vinyl esters), poly(urethanes), phenoxy resins, poly(vinylidene chloride), poly(epoxides), poly(carbonates), poly(vinyl acetate), cellulose esters, poly(amides), as well as polyvinyl butyral, cellulose acetate, cellulose acetate butyrate, polyester, polycarbonate, polyacrylic acid, and polyurethane as a transparent hydrophobic binder.

These thickeners may be used in combination with at least two kinds. There are further cited the compounds described on pages 71-75 of Japanese Patent O.P.I. Publication No. 64-13546. Of these, polyvinyl alcohols, polyvinylpyrrolidones, hydroxypropyl celluloses, and polyalkylene glycols are preferably used in view of compatibility with various types of additives and enhancement of dispersion stability of white particles.

In the display element of the present invention, polyethylene glycol having an average polymerization degree of 10-500 is preferable as a thickener, and preferably has an addition amount of 5-20% by weight, with respect to an organic solvent in an electrolyte layer.

### [Electrochromic Compound]

An electrochromic compound exhibiting an electrochromic property is usable in an electrolytic solution of the present invention.

The electrochromic compound in the present invention (EC compound) is not specifically limited as long as action of coloration or decoloration thereof is produced via at least one of electrochemical oxidation reaction and electrochemical reduction reaction, and it can be appropriately selected in response to the intended purpose. Examples of known EC compounds include an organic metal complex, an electrically conductive polymeric compound and an organic dye in addition to inorganic compounds such as tangusten oxide, iridium oxide, nickel oxide, cobalt oxide, vanadium oxide, molybdenum oxide, titanium oxide, indium oxide, chrome oxide, manganese oxide, Prussian blue, indium nitride, tin nitride, zirconium nitride chloride and so forth.

Examples of the organic metal complex exhibiting an electrochromic property include a metal-bipyridyl complex, a metal phenanthroline complex, a metal-phthalocyanine complex, a rare-earth diphthalocyanine complex, a ferrocene based dye and so forth.

Examples of the electrically conductive polymeric compound exhibiting an electrochromic property include polypyrrole, polythiophene, polyisothianaphthene, polyaniline, polyphenylenediamine, polybenzidine, polyaminophenol, polyvinylcarbazole, polycarbazole, and derivatives thereof.

A polymeric material formed from a bister-pyridine derivative and metal ions as described in Japanese Patent O.P.I. Publication No. 2007-112957 also exhibits an electrochromic property.

Examples of the organic dye exhibiting an electrochromic property include a pyridinium based compound such as viologen or the like, an azine based dye such as phenothiazine or the like, a styryl based dye, an anthraquinone based dye, a pyrazoline based dye, a fluoran based dye, a donor/acceptor type compounds (for example, tetracyanoquinomethane and tetrathiafulvalene) and so forth. Others such as compounds known as a redox indicator or a pH indicator are also usable.

### (Classification of EC Compounds by Color Tone)

When classifying the EC compound based on change in color tone, it is divided into the following 3 classes.

Class 1: An EC compound changed from a specific color to another color via redox.

Class 2: An EC compound which is substantially achromatic in an oxidization state, and exhibits a certain specific colored state in a reduction state.

Class 3: An EC compound which is substantially achromatic in a reduction state, and exhibits a certain specific colored state in an oxidization state.

As to a display element of the present invention, an EC compound can be appropriately selected from the above-described Classes 1-3, depending on an object or use application.

### <EC Compound of Class 1>

The EC compound of Class 1 is an EC compound changed from a specific color to another color via redox, and is a compound capable of displaying at least two colors in a possibly generating oxidation state thereof.

As a compound classified into Class 1, for example, V₂O₅ appears to be changed from orange to green by changing from an oxidization state to a reduction state, and Rh₂O₃ similarly appears to be changed from yellow to dark green.

Many of organic metal complexes are classified into Class 1, and a ruthenium (II) bipyridine complex, for example, a tris (5,5′-dicarboxylethyl-2,2′-bipyridine) ruthenium complex appears to be changed in order from orange to violet, blue, Montpellier green, midium brown, red rust color and red between plus divalence and minus tetravalence. Many of rare-earth diphthalocyanines exhibit such a multicolor property. For example, in the case of rutetium phthalocyanine, change from violet to blue, green and red-orange color in order occurs via oxidization.

Further, many of electrically conductive polymers are classified into Class 1. For example, polythiophene appears to be changed from blue to red by changing from the oxidization state to the reduction state, and polypyrrole appears to be changed from medium brown to yellow. Further, polyaniline or the like exhibits a multicolor property, and appears to be changed from dark blue in the oxidization state to blue, green and light yellow in order.

The EC compound classified into Class 1 has the advantage that multicolor displaying is possible with a single compound, but in contrast, the EC compound is disadvantageous in that a substantially achromatic state can not be produced.

### <EC Compound of Class 2>

The EC compound of Class 2 is a compound exhibiting achroma to extremely pypochromatic color in an oxidization state, and exhibiting a certain specific colored state in a reduction state.

As inorganic compounds classified into Class 2, the following compounds are cited, and each exhibit color indicated in a parenthesis in the reduction state. WO₃ (blue), MnO₃ (blue), Nb₂O₅ (blue), and TiO₂ (blue).

As an organic metal complex classified into Class 2, a tris (bathophenanthroline) iron (II) complex is provided, for example, and exhibits red in the reduction state.

As organic dyes classified into Class 2, provided are compounds disclosed in Japanese Patent O.P.I. Publication No. 62-71934, Japanese Patent O.P.I. Publication No. 2006-71765 and so forth and so forth, for example, dimethyl terephthalate (red), 4,4′-biphenyl diethyl carboxylate (yellow), 1,4-diacetyl benzene (cyan), or tetrazolium salt compounds disclosed in Japanese Patent O.P.I. Publication No. 1-230026, Published Japanese translation of PCT international Publication No. 2000-504764 and so forth.

As dyes classified into Class 2, most typical compounds are pyridium based compounds such as viologen and so forth. Since viologen based compounds are advantageous in that displaying is clear, and color variation via replacement of a substituent is possible to be possessed, most intensive studies of this have been made among organic dyes. Color formation is based on organic radicals generated in the reduction.

As the pyridinium based compound such as viologen or the like, provided are compounds disclosed in the following patents in addition to Published Japanese Translation of PCT international Publication No. 2000-506629.

Japanese Patent O.P.I. Publication No. 5-70455, Japanese Patent O.P.I. Publication No. Japanese 5-170738, Patent O.P.I. Publication No. 2000-235198, Japanese Patent O.P.I. Publication No. 2001-114769, Japanese Patent O.P.I. Publication No. 2001-172293, Japanese Patent O.P.I. Publication No. 2001-181292, Japanese Patent O.P.I. Publication No. 2001-181293, Published Japanese Translation of PCT International Publication No. 2001-510590, Japanese Patent O.P.I. Publication No. 2004-101729, Japanese Patent O.P.I. Publication No. 2006-154683, Published Japanese Translation of PCT International Publication No. 2006-519222, Japanese Patent O.P.I. Publication No. 2007-31708, Japanese Patent O.P.I. Publication No. 2007-171781, Japanese Patent O.P.I. Publication No. 2007-219271, Japanese Patent O.P.I. Publication No. 2007-219272, Japanese Patent O.P.I. Publication No. 2007-279659, Japanese Patent O.P.I. Publication No. 2007-279570, Japanese Patent O.P.I. Publication No. 2007-279571, Japanese Patent O.P.I. Publication No. 2007-279572, and so forth.

Pyridinium compounds such as viologen and so forth, which are usable in the present invention are exemplified below, but the present invention is not limited thereto.

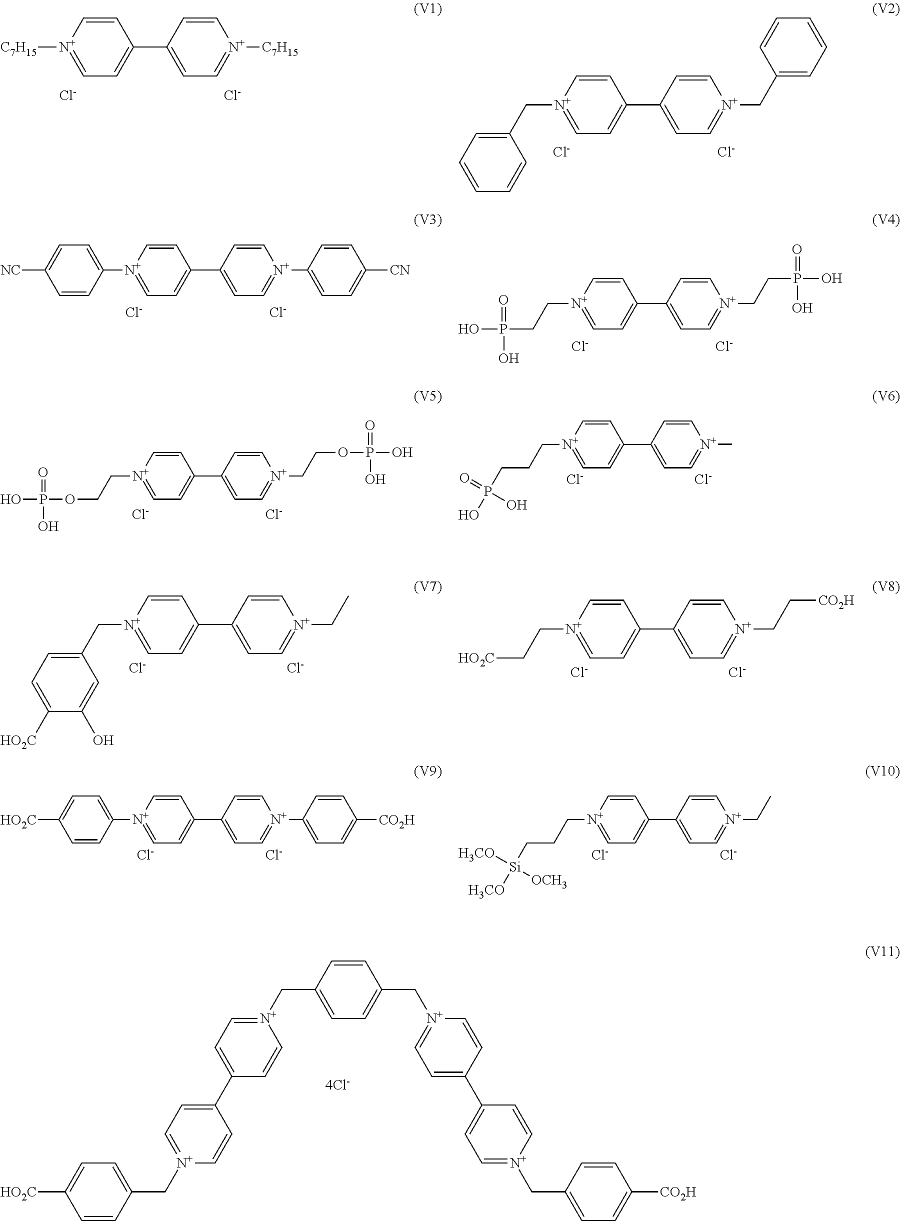

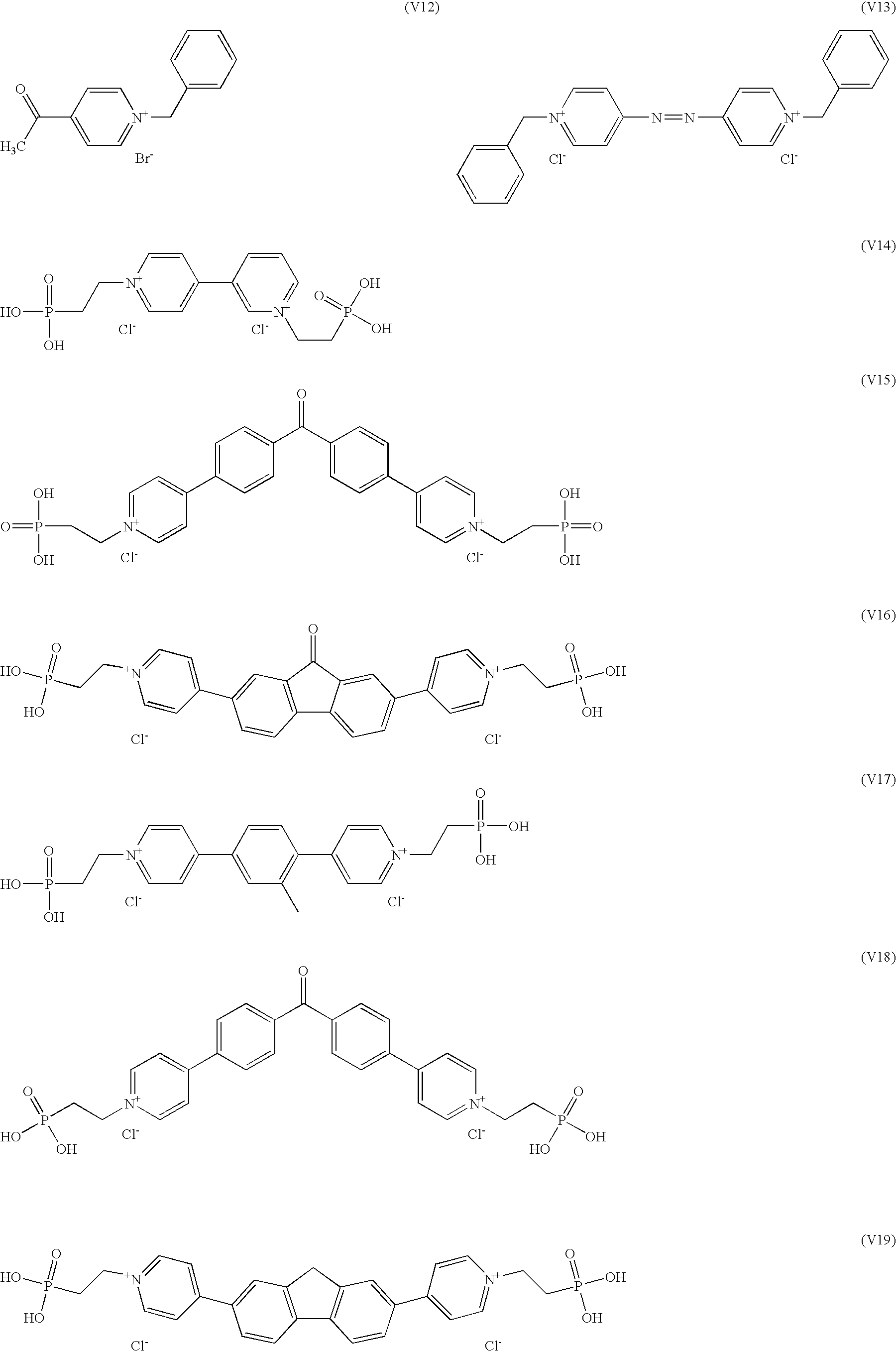

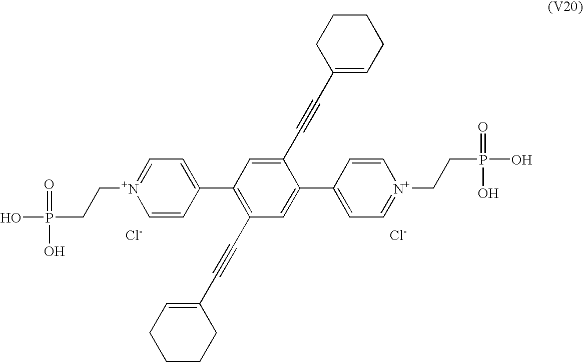

### <EC Compound of Class 3>

The EC compound of Class 3 is a compound exhibiting achroma to extremely pypochromatic color in a reduction state, and exhibiting a certain specific colored state in an oxididation state.

As inorganic compounds classified into Class 3, for example, iridium oxide (dark blue), Prussian blue (blue) and so forth are provided (each exhibiting color indicated in a parenthesis in the oxidization state).

As the electrically conductive polymer classified into Class 3, not many examples are seen, but for example, a phenyl ether based compound disclosed in Japanese Patent O.P.I. Publication No. 6-263846 is provided.

As dyes classified into Class 3, many dyes are known, but preferable examples thereof include styryl based dyes, azine based dyes such as phenazine, phenothiazine, phenoxazine and acridine, and azole based dyes such as imidazole, oxazole and thiazole.

Styryl based dye, azine based dyes and azole based dyes usable in the present invention are exemplified below, but the present invention is not limited thereto.

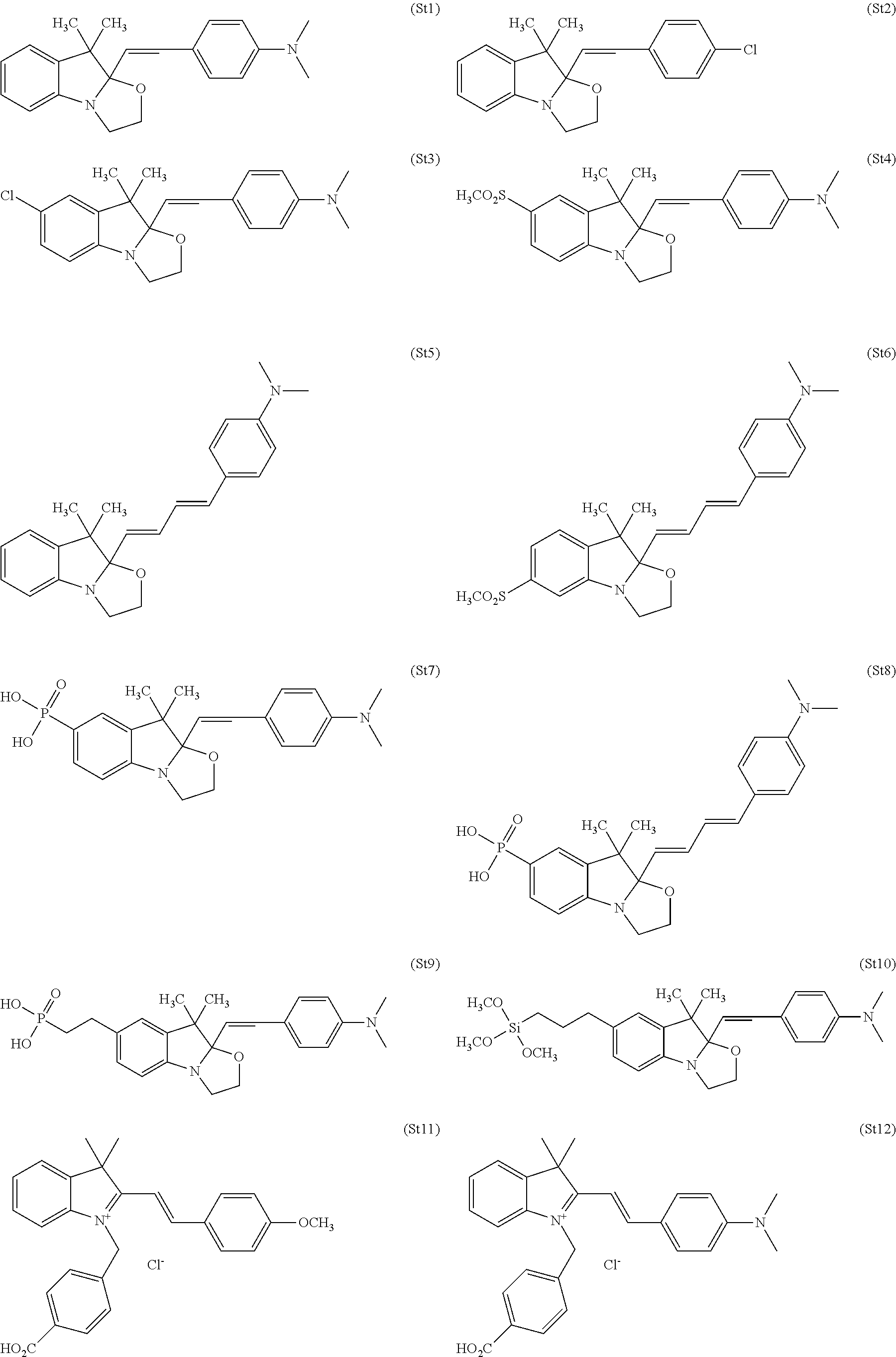

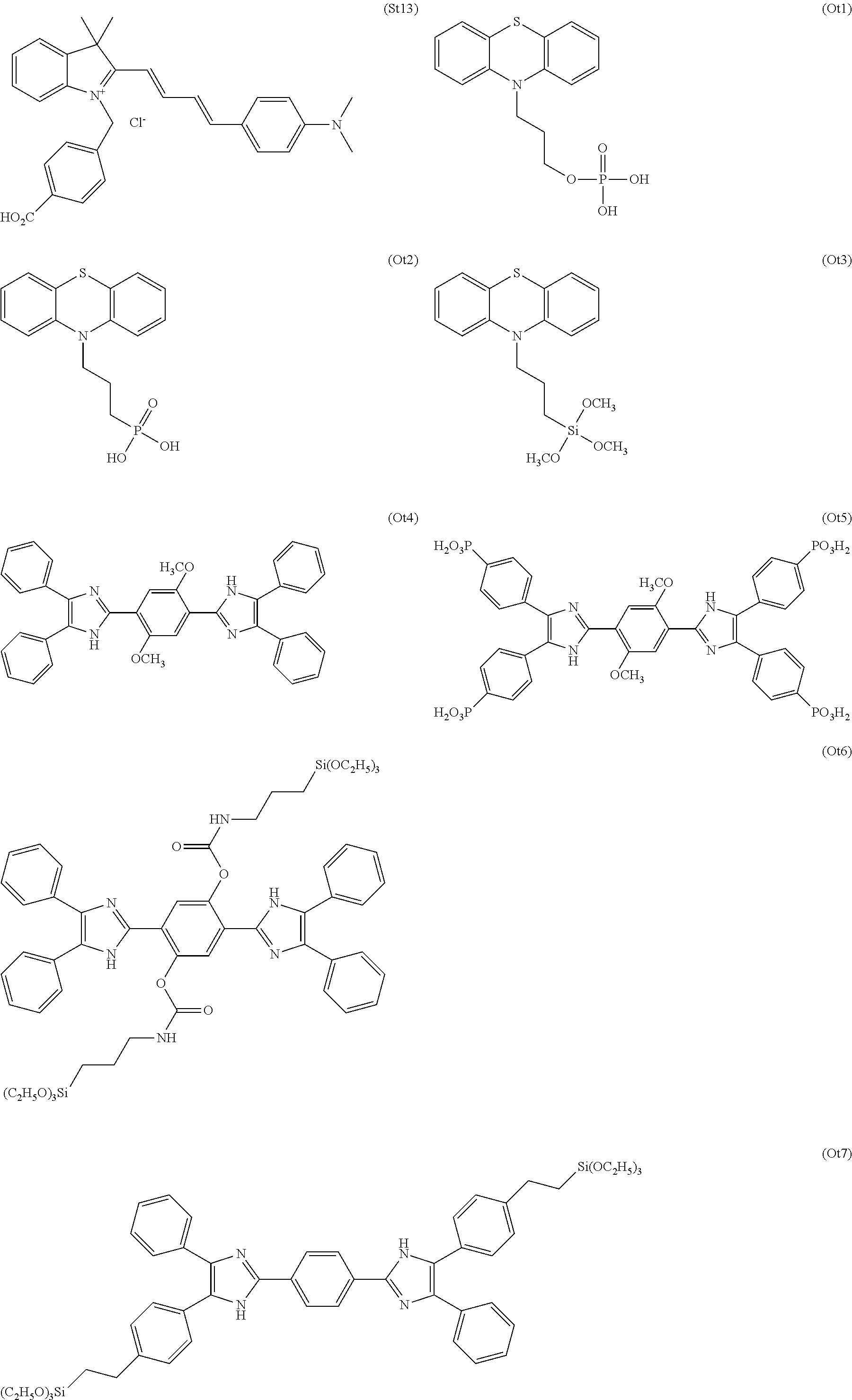

In a preferred embodiment of the present invention, a metal salt reversibly dissolved and deposited via electrochemical redox reaction is used in combination with the foregoing EC dye to conduct displaying of multicolor of at least 3 colors like a black display, a white display and a colored display other than black. In this case, in order to conduct the black display via reduction of the metal salt, the EC compound of Class 3 forming color via oxidization is preferred as an EC dye, and an azole based dye is specifically preferable in view of color formation diversity, low driving voltage and a memory property and so forth.

### [Compound Represented by Formula (L)]

In the present invention, the most preferable dye is a compound represented by the following Formula (L).

Next, the electrochromic compound represented by foregoing Formula (L) in the present invention will be described.

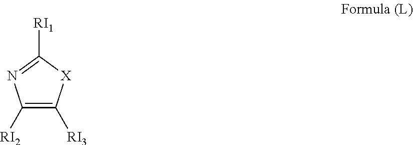

In the foregoing Formula (L), Rl₁ represents a substituted or unsubstituted aryl group; each of Rl₂ and Rl₃ represents a hydrogen atom or a substituent; and X represents >N-Rl₄, an oxygen atom or a sulfur atom, wherein Rl₄ represents a hydrogen atom or a substituent.

When Rl₁ represents an aryl group having a substituent, the substituent is nor specifically limited, and for example, the following substituents are listed.

Provided can be an alkyl group (for example, a methyl group, an ethyl group, a propyl group, an isopropyl group, a t-butyl group, a pentyl group or a hexyl group), a cycloalkyl group (for example, a cyclohexyl group or a cyclopentyl group), an alkenyl group, a cycloalkenyl group, an alkynyl group (for example, a propargyl group), a glycidyl group, an acrylate group, a methacrylate group, an aromatic group (for example, a phenyl group, a naphthyl group or an anthracenyl group), a heterocyclic group (for example, a pyridyl group, a thiazolyl group, an oxazolyl group, an imidazolyl group, a furyl group, a pyrrolyl group, a pyrazinyl group, a pyrimidinyl group, a pyridazinyl group, a selenazolyl group, a sulfolanyl group, a piperidinyl group, a pyrazolyl group or a tetrazolyl group), an alkoxy group (for example, a methoxy group, an ethoxy group, a propyloxy group, a pentyloxy group, a cyclopentyloxy group, a hexyloxy group or a cyclohexyloxy group), an aryloxy group (for example, a phenoxy group), an alkoxylcarbonyl group (for example, a methyloxycarbonyl group, an ethyloxycarbonyl group or a butyloxycarbonyl group), an aryloxycarbonyl group (for example, a phenyloxycarbonyl group), a sulfonamide group (for example, a methane sulfonamide group, an ethane sulfonamide group, a butane sulfonamide group, a hexane sulfonamide group, a cyclohexane sulfonamide group or a benzene sulfonamide group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, a phenylaminosulfonyl group or a 2-pyridylaminosulfonyl group), a urethane group (for example, a methylureide group, an ethylureide group, a pentylureide group, a cyclohexylureide group, a phenylureide group or a 2-pyridylureide group), an acyl group (for example, an acetyl group, a propionyl group, a butanoyl group, a hexanoyl group, a cyclohexanoyl group, a benzoyl group or a pyridinoyl group), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, a phenylaminocarbonyl group or a 2-pyridylaminocarbonyl group), an acylamino group (for example, an acetylamino group, a benzoylamino group or a methylureide group), an amide group (for example, an acetamide group, a propionamide group, a butanamide, a hexanamide or a benzamide group), a sulfonyl group (for example, a methylsulfonyl group, an ethylsulfonyl group, a butylsulfonyl group, a cyclohexylsulfonyl group a phenylsulfonyl group or a 2-pyridylsulfonyl group), a sulfonamide (for example, a methylsulfonamide group, an octylsulfonamide group, a phenylsulfonamide group or a naphthylsulfonamide group), an amino group (for example, an amino group, an ethylamino group, a dimethylamino group, a butylamino group, a cyclopentylamino group, an anilino group or a 2-pyridylamino group), a halogen atom (for example, a chlorine atom, a bromine atom or an iodine atom), a cyano group, a nitro group, a sulfo group, a carboxyl group, a hydroxyl group or a phosphono group (for example, a phosphonoethyl group, a phosphonopropyl group or a phosphonooxyethyl group). These groups may further be substituted by any of these ones.

As Rl₁, preferable is a substituted or unsubstituted phenyl group, and more preferable is a substituted or unsubstituted 2-hydroxyphenyl group or a substituted or unsubstituted 4-hydroxyphenyl group.

Substituents represented by Rl₂ or Rl₃ are not specifically limited, and those exemplified as substituents each onto an aryl group for the foregoing R_{L1} are provided. Rl₂ and Rl₃ each is preferably alkyl group, a cycloalkyl group, an aromatic group or a heterocycle group, which may have a substituent. Rl₂ and Rl₃ are connected to each other to form a cyclic structure. As the combination of Rl₂ or Rl₃, there is a case where both of them each are a phenyl group or a heterocyclic group, which may have a substituent, or another case where one of them is a phenyl group or a heterocyclic group, which may have a substituent, and another one is an alkyl group, which may have a substituent.

X is preferably >N-Rl₄. Rl₄ is preferably a hydrogen atom, an alkyl group, an aromatic group, a heterocycle group or an acyl group, and more preferably a hydrogen atom, an alkyl group having 1-10 carbon atoms, an aryl group having 5-10 carbon atoms or an acyl group.

In a display element of the present invention, a compound represented by foregoing Formula (L) in the present invention preferably has a group chemically or physically adsorbed onto the electrode surface. The chemical adsorption of the present invention means a relatively strong adsorption state via chemical bonding to the electrode surface, and the physical adsorption of the present invention means a relatively weak adsorption state via van der Walls force acting between the electrode surface and an adsorbed substance.

An adsorption group in the present invention is preferably a chemical adsorption group, and as a chemically adsorbing adsorption group, preferable are —COOH, —P═O(OH)₂, —OP═O(OH)₂, and —Si(OR)₃ where R represents an alkyl group.

Among azole dyes represented by Formula (L), an imidazole based dye represented by the following Formula (L2) is specifically preferable.

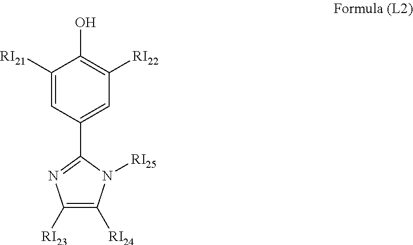

In Formula (L2), each of Rl₂₁ or Rl₂₂ represents an aliphatic group, an aliphatic oxy group, an acylamino group, a carbamoyl group, an acyl group, a sulfoamide group or sulfamoyl group; Rl₂₃ represents an aromatic group or an aromatic heterocyclic group; Rl₂₄ represents a hydrogen atom, an aliphatic group, an aromatic group or an aromatic heterocycle group; and Rl₂₅ represents a hydrogen atom, an aliphatic group, an aromatic group or an acyl group.

Groups represented by these Rl₂₁-Rl₂₅ may be further substituted by arbitrary substituents. However, at least one of groups represented by Rl₂₁-Rl₂₅ has —COOH, —P═O(OH)₂ or —Si(OR)₃ where R is represented by an alkyl group, as a partial structure thereof.

In Formula (L2), as groups represented by Formulae Rl₂₁ and Rl₂₂, an alkyl group (specifically, branched alkyl group), a cycloalkyl group, an alkyloxy group or a cycloalkyloxy group is preferable. Rl₂₃ is preferably a substituted or unsubstituted phenyl group, or a 5 or 6-membered heterocyclic group (for example, a thienyl group, a furyl group, a pyrrolyl group, a pyridyl group and so forth). Rl₂₄ is preferably a substituted or unsubstituted phenyl group, a 5 or 6-membered heterocyclic group or an alkyl group. Rl₂₅ is preferably a hydrogen atom or an aryl group.

Further, when a compound represented by Formula (L2) is immobilized on an electrode, at least one of groups represented by Rl₂₁-Rl₂₅ preferably has —P═O(OH)₂ or —Si(OR)₃ where R is represented by an alkyl group, as a partial structure thereof, and specifically, a group represented by Rl₂₃ or Rl₂₄ preferably has —Si(OR)₃ where R is represented by an alkyl group, as a partial structure.

Specific compound examples of the EC dye represented by Formula (L2) and Specific examples of the EC dye included in Formula (L) though not falling into Formula (L), but the present invention is not limited only to these exemplified compounds.

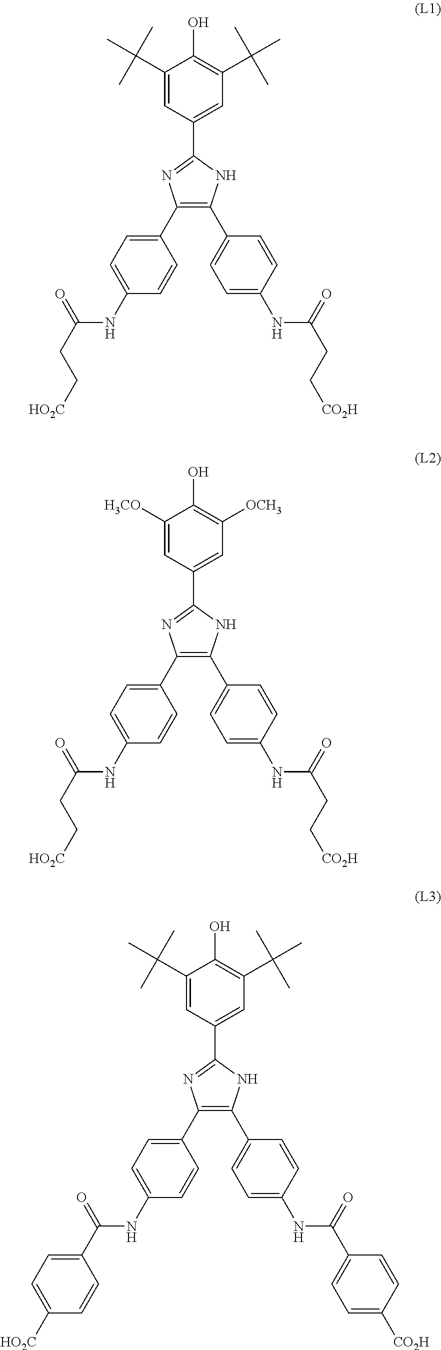

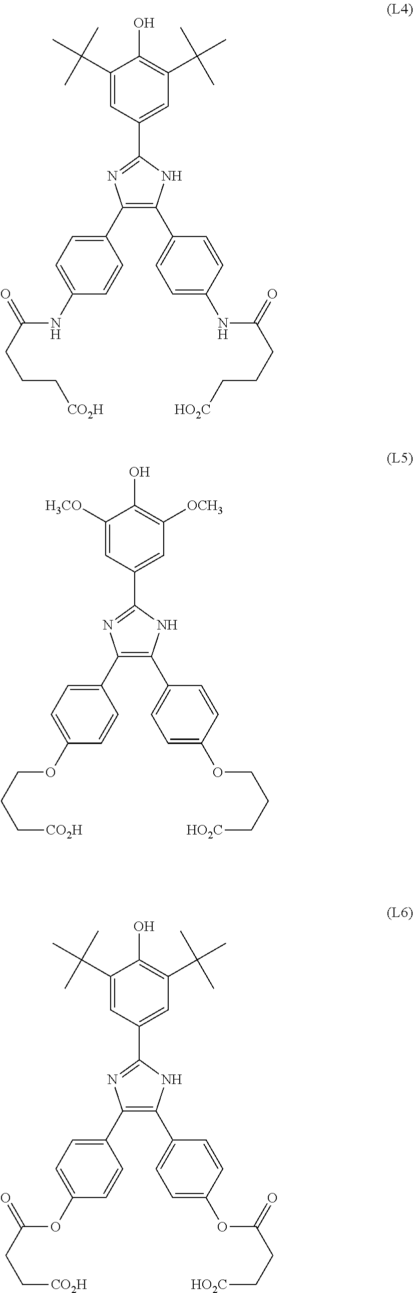

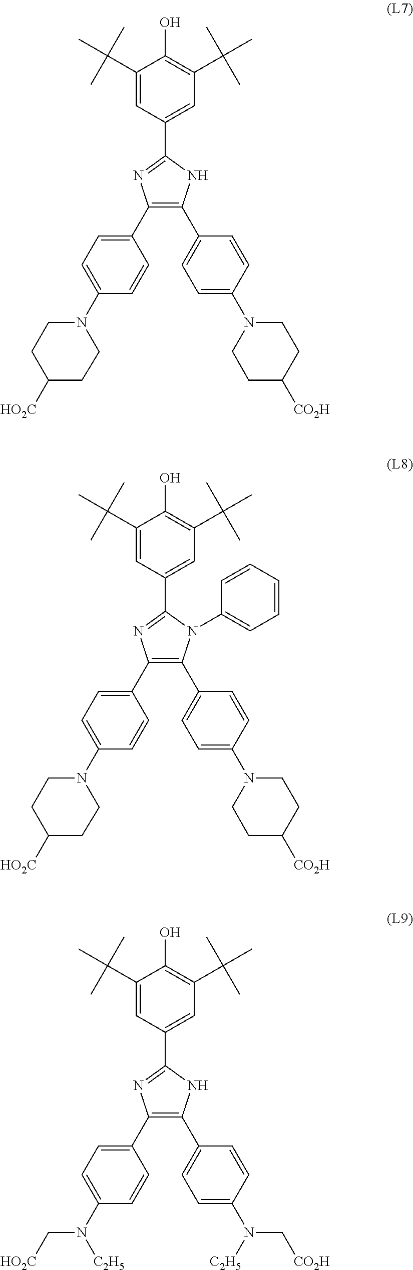

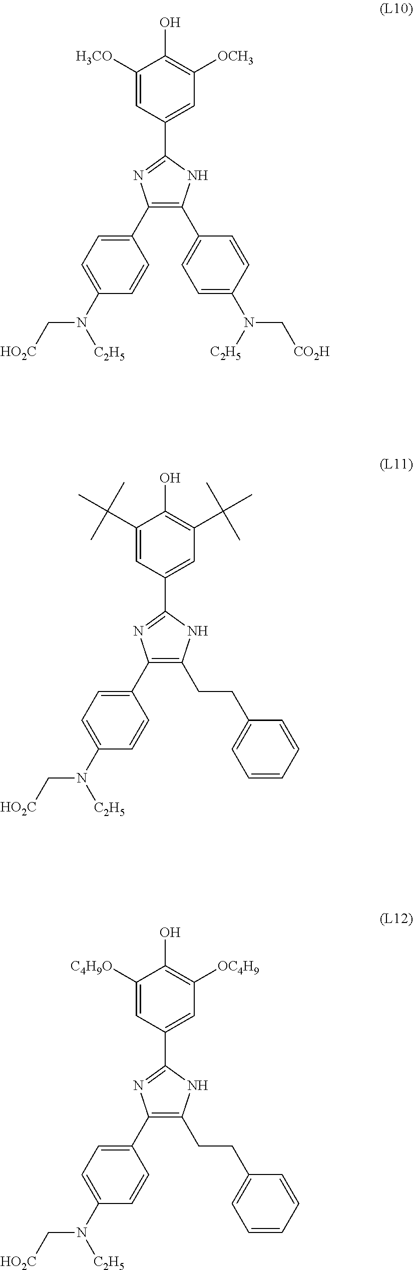

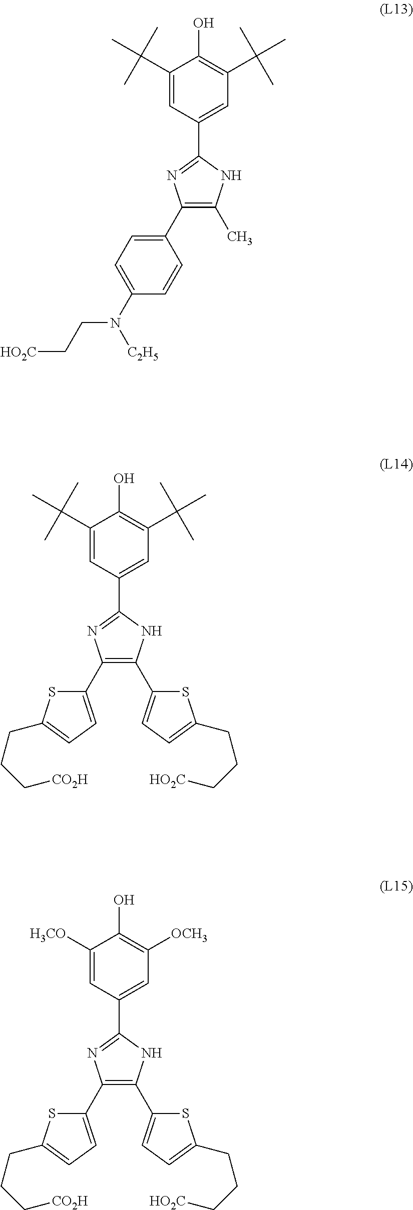

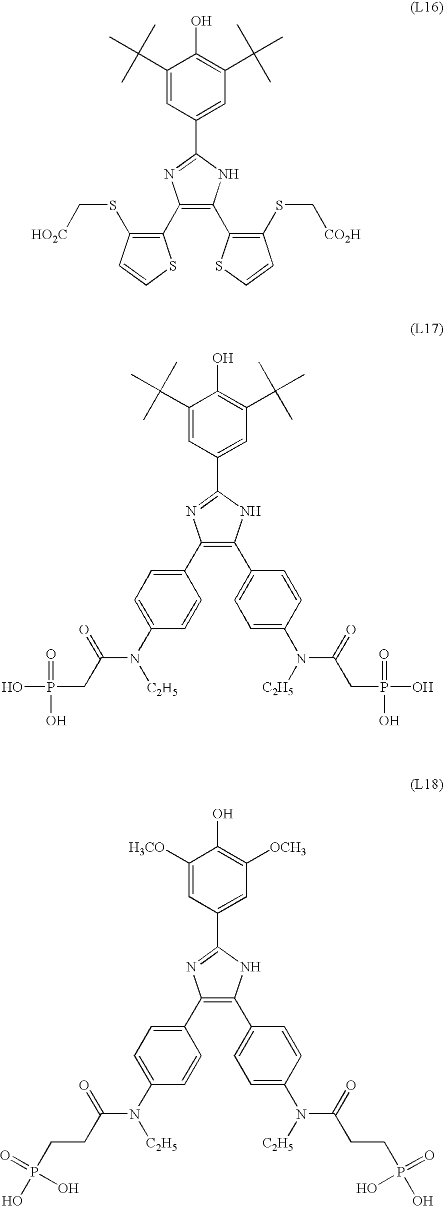

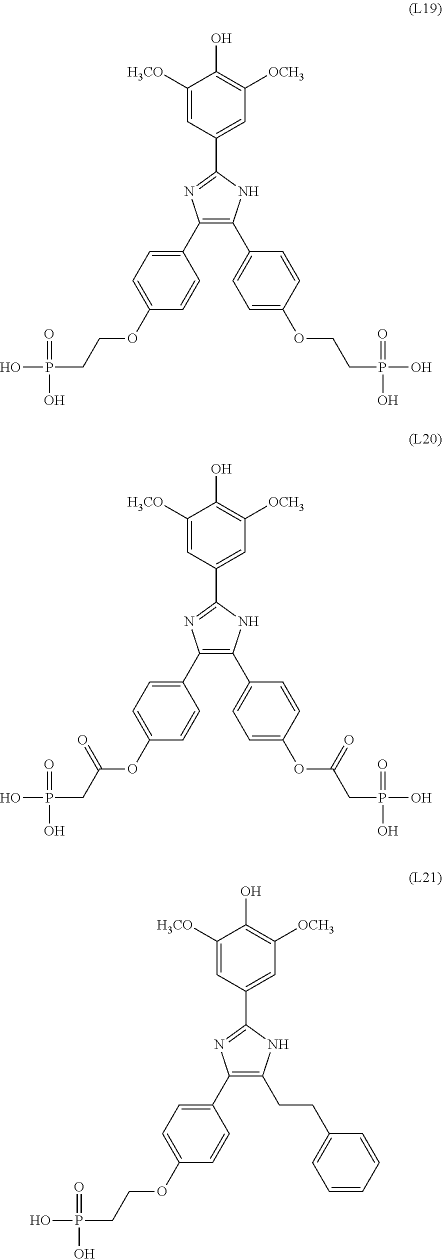

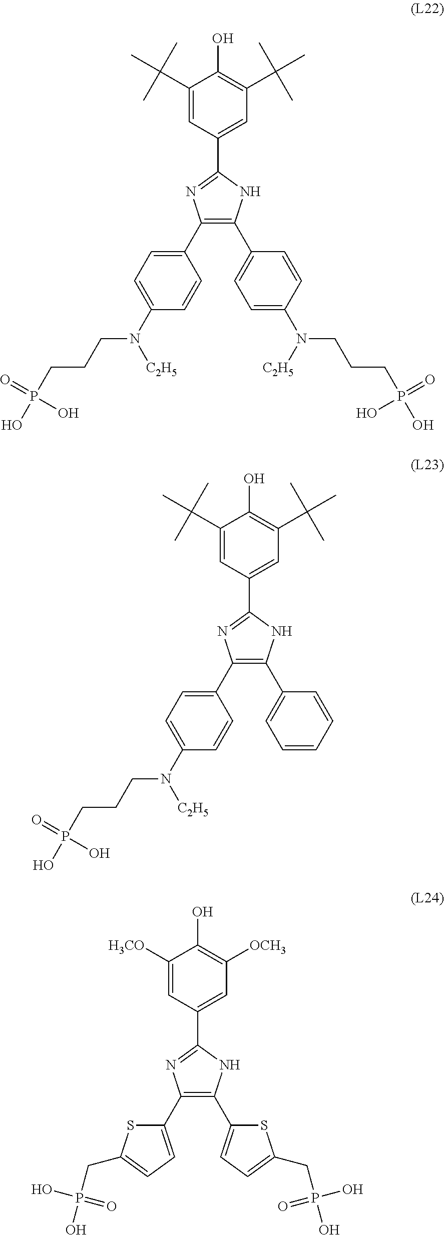

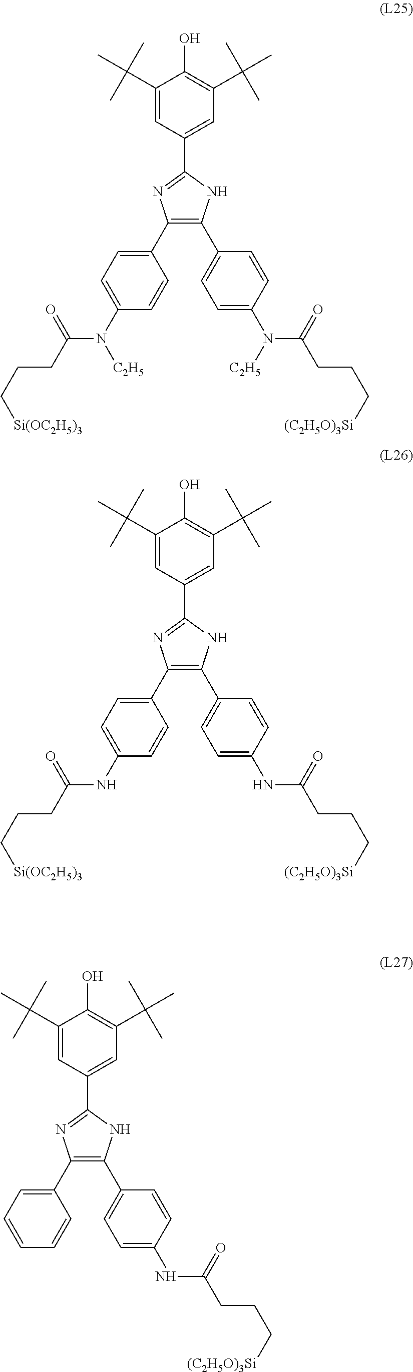

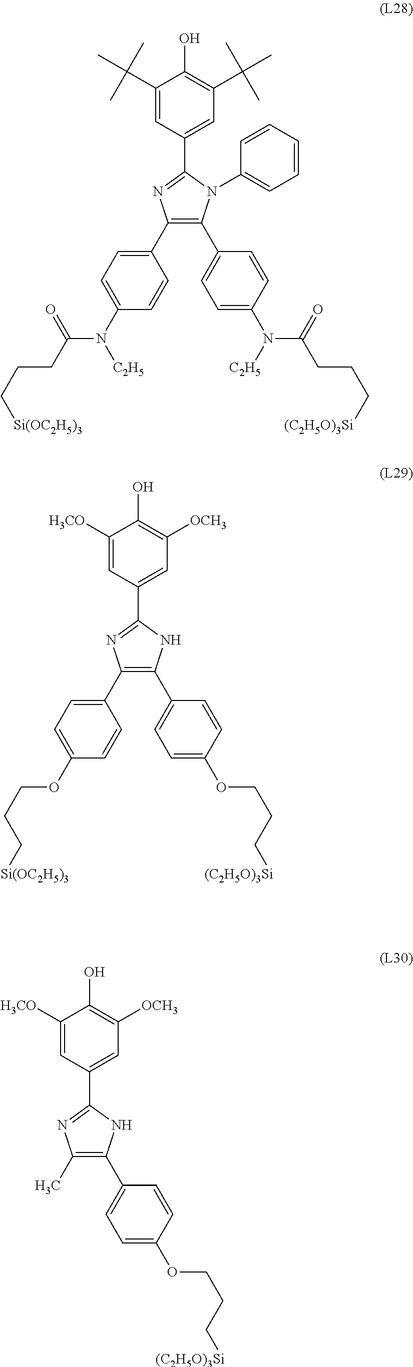

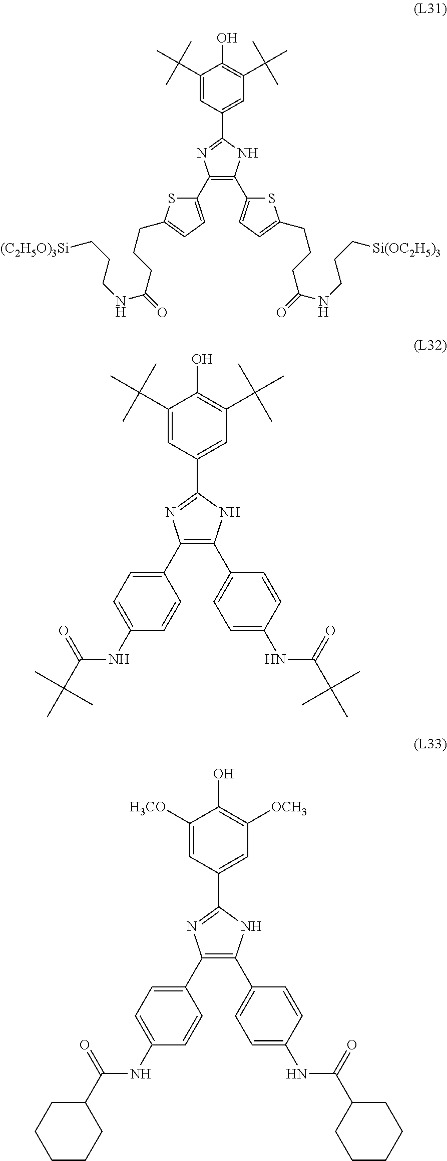

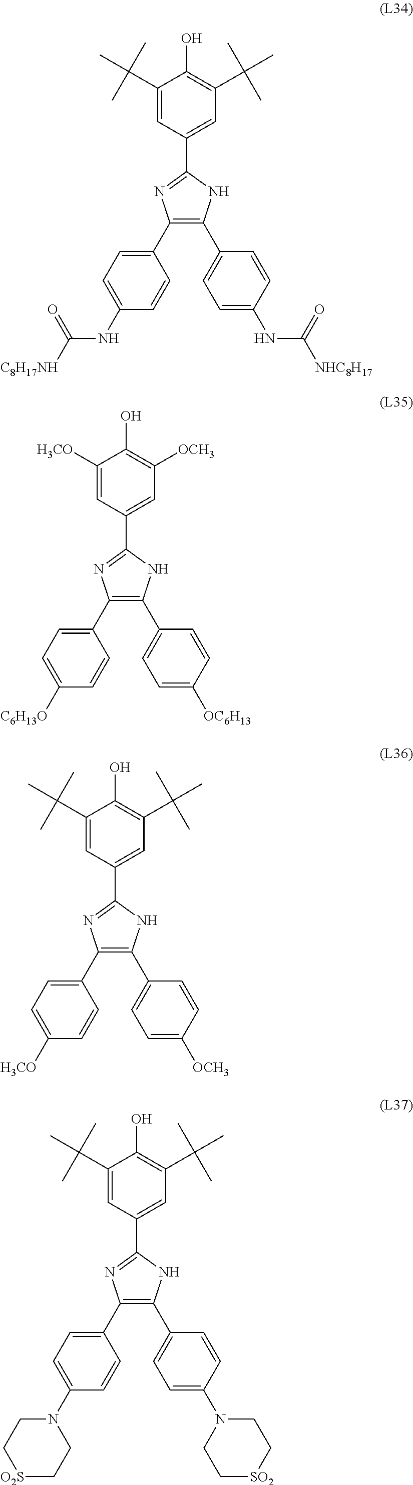

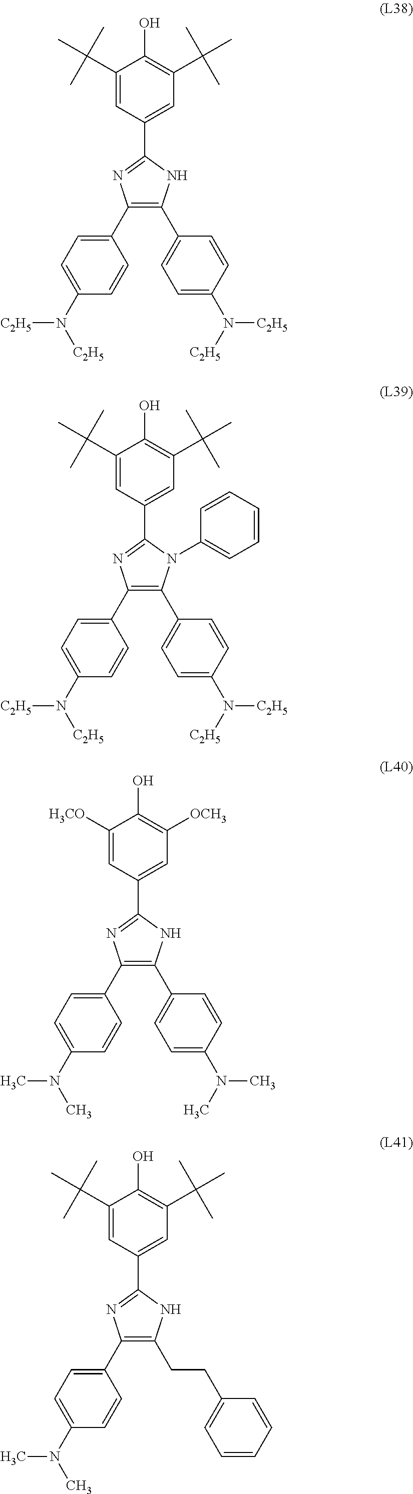

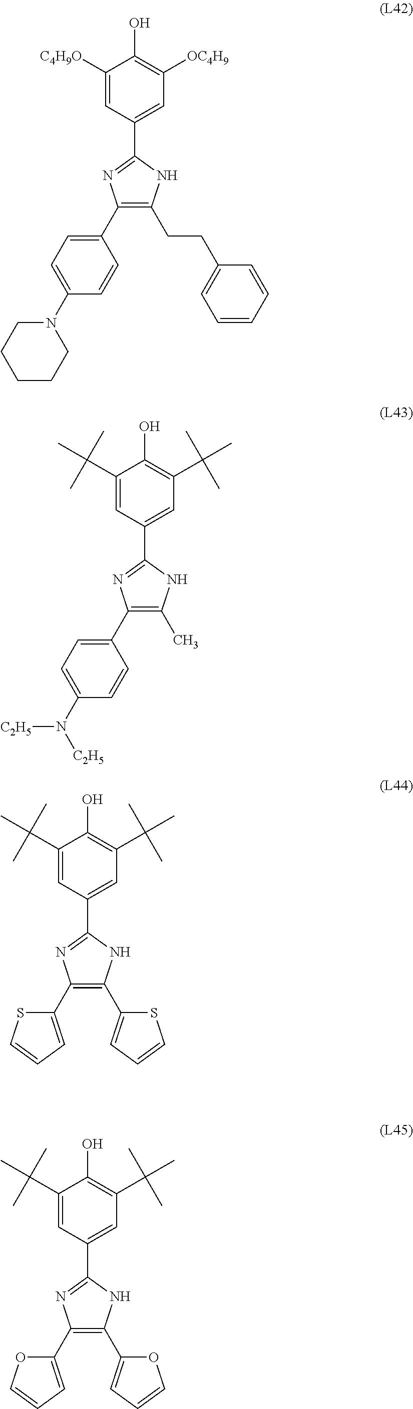

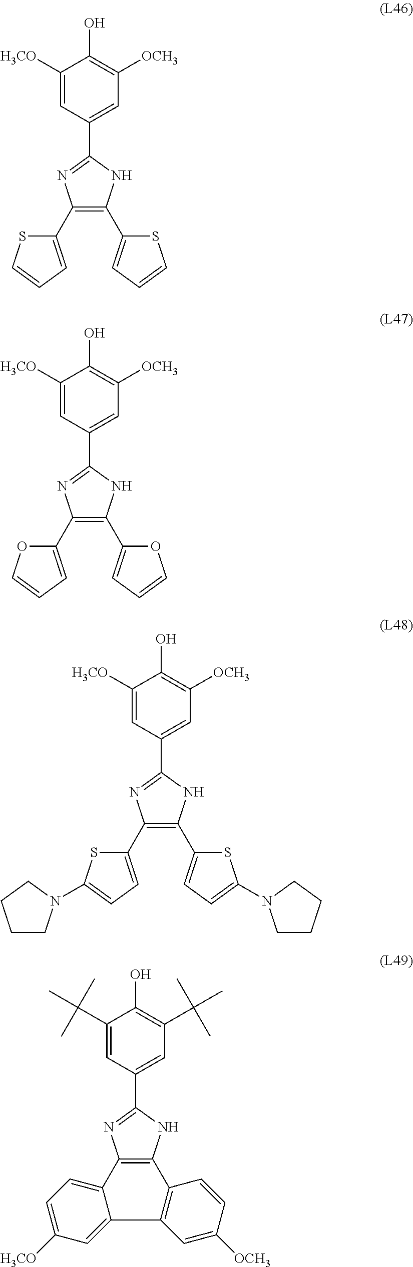

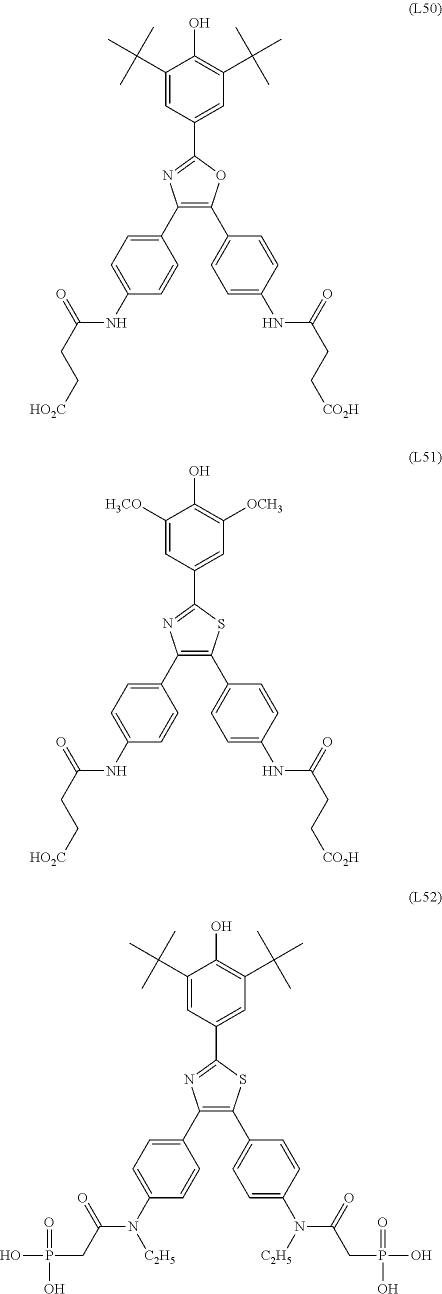

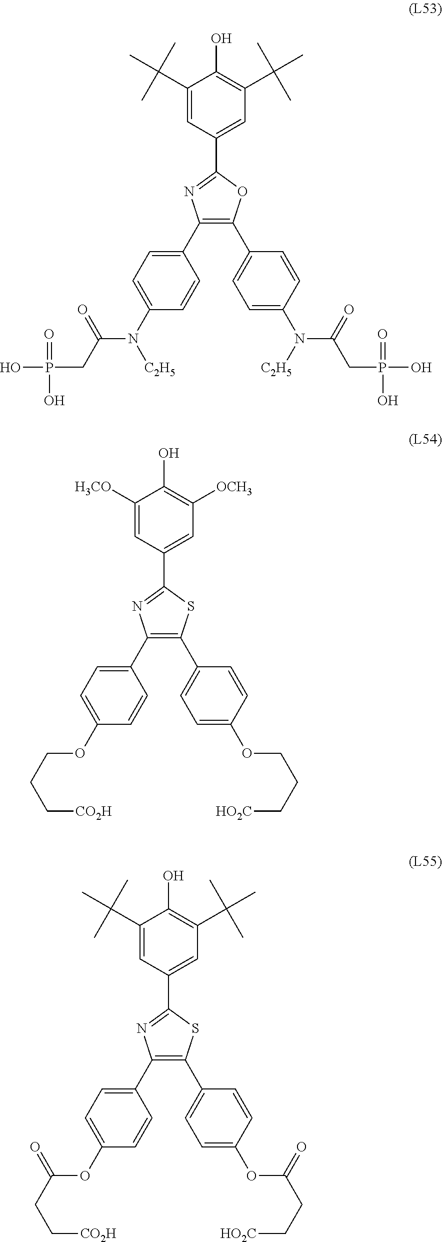

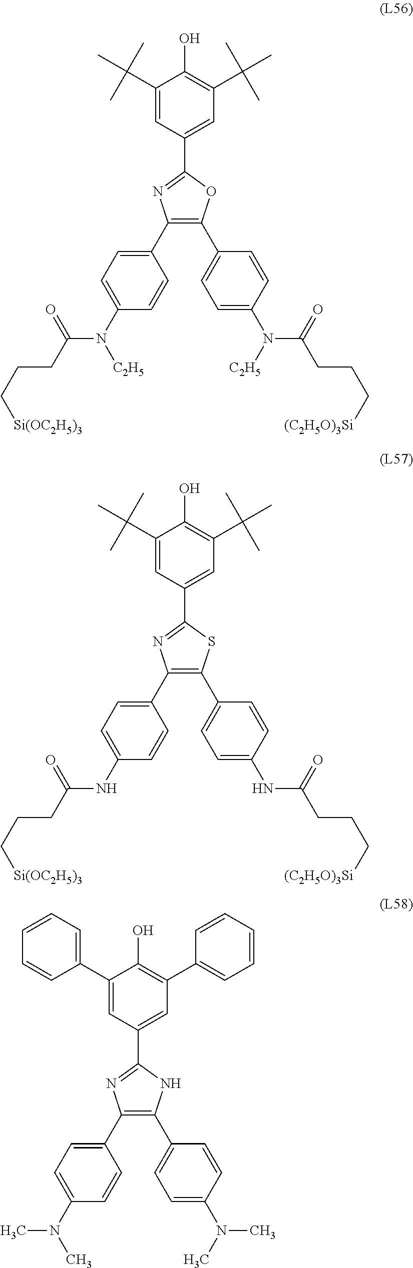

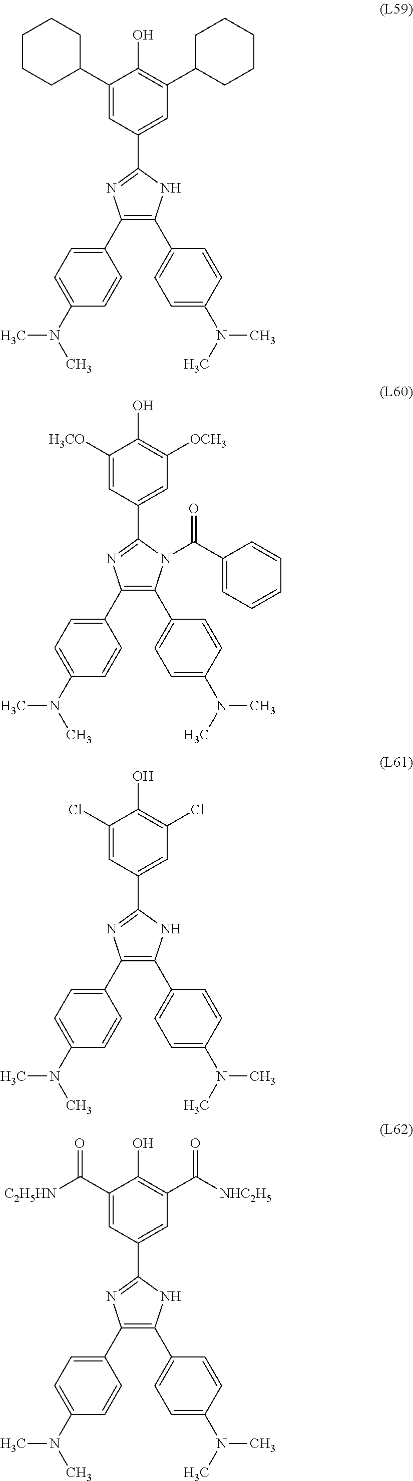

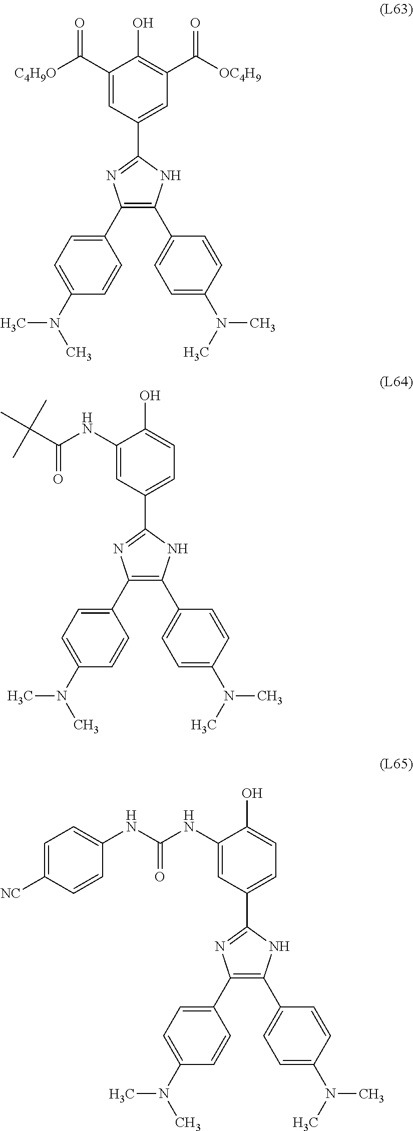

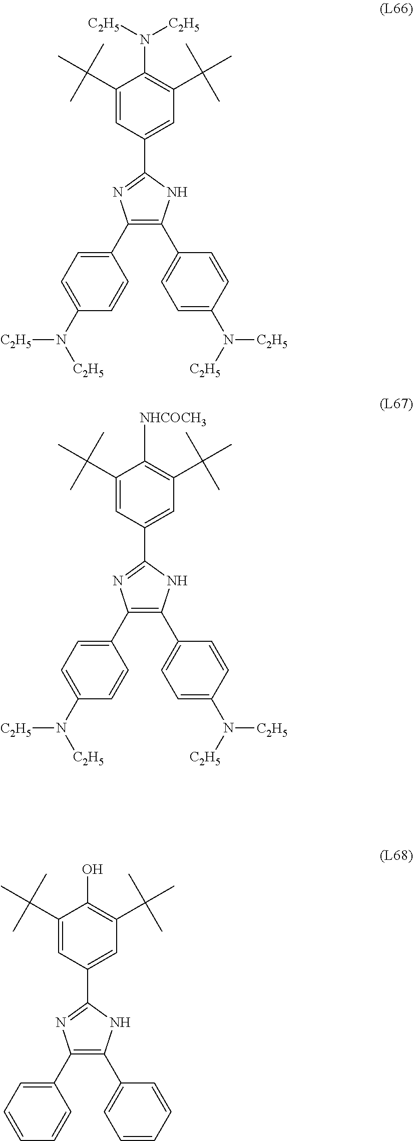

The electrochromic compound is preferably immobilized on an electrode on the viewing side (display side). When it is immobilized on the electrode on the viewing side, viewing concentration can be improved.

### [Promoter]

As to a display element of the present invention, an auxiliary compound (hereinafter, referred to as a promoter) is preferably added in order to promote electrochemical reaction of a compound capable of reversibly changing color via electrochemical redox reaction. From the result of redox reaction, the promoter may be one whose optical density is not changed in the visible range of 400-700 nm; may be one whose optical density is changed in the visible range, that is, may be the foregoing compound capable of reversibly changing color via electrochemical redox reaction; may be immobilized on a electrode; and may be added into an electrolytic solution. It appears that the promoter, for example, is utilized as an antipole reactant, or as a redox mediator.

For example, when a compound capable of reversibly changing color via electrochemical redox reaction on produces color on the display electrode side via oxidization (or reduction), high color-producing density is possible to be obtained at low driving voltage by using reducing (or oxidizing) reaction of the promoter on the facing electrode side. In this way, when the promoter is utilized as an antipole reactant, it is preferred that a promoter exhibiting redox activation, reversely to a compound capable of reversibly changing color via electrochemical redox reaction is immobilized on the facing electrode, and used. When the promoter is used as an antipole material, the promoter is preferably one in which optical density is not changed at a visible range of 400-700 nm, based on the result of redox reaction. However, as described in preferred embodiments of the present invention, in the case of an embodiment in which color produced by the promoter is blocked by employing a white scattering material in the display element, the promoter whose optical density changes at a visible range of 400-700 nm, that is, a compound capable of reversibly changing color via electrochemical redox reaction may be used. An embodiment with such a structure is preferable since a promoter is easily selected. Further, it is a preferred embodiment that a promoter exhibiting the same color produced as that of a compound capable of reversibly changing color via electrochemical redox reaction on the display electrode side is used as another embodiment.

On the other hand, a redox mediator is a material conventionally used in the field of organic electrolysis synthesis. Each organic compound has an oxidization voltage depending on an electrolysis method and electrolysis conditions in addition to specific oxidation potential, and oxidation reaction is practically produced when the anode potential is higher than the oxidation potential accompanied with the above-described. Since the anode potential has the experimental limit, it is impossible to entirely oxidize a substrate by a direct method. When oxidizing a substrate having high oxidizing potential, no electron is moved from the substrate to an anode. When this reaction system coexists with such a mediator that electron movement to the anode (oxidization) is produced at low potential, the mediator is first oxidized, and the substrate is oxidized with the oxidized mediator to obtain a product. The advantage of this reaction system is that it is possible to oxidize the substrate at anode potential lower than oxidization potential of the substrate, and the oxidized mediator theoretically acts as a catalyst since it moves back to the original mediator by oxidizing the substrate. Further, since oxidization at low potential becomes possible, decomposition of the substrate and the product can be inhibited.

In the present invention, for example, when used is a compound capable of reversibly changing color via electrochemical redox reactor, which produces color via oxidization as the foregoing substrate, it becomes possible to drive a display element at low driving voltage by coexisting with the oxidization mediator as catalyst quantity, and durability of the display element is increased. Further, it is advantageous that display-replacing speed is increased, and high color-producing efficiency is obtained. Similarly, the above-described effect can be produced by using a reduction mediator and a compound capable of reversibly changing color via electrochemical redox reaction, which produces color via reduction, in combination.

In the display element of the present invention, as shown in the field of organic electrolysis synthesis, a single mediator may be used, or a plurality of mediators are used in combination. When the promoter is issued as a mediator in the present invention, a compound capable of reversibly changing color via electrochemical redox reaction is immobilized on the display electrode, the promoter is preferably localized in the vicinity of the material to use it.

In the present invention, the promoter may be used as an antipole reactant, or it is also used as a mediator. For the purpose of both of them, a plurality of promoters may be simultaneously used in combination.

Promoters are not specifically limited, and can be appropriately selected based on the intended purpose. When it is utilized as an antipole reactant, a compound capable of reversibly changing color via electrochemical redox reaction is possible to be employed. Further, when it is used as a redox mediator, commonly known mediators described in Yuki Gosei Kagaku Kyokaishi (Journal of Synthetic Organic Chemistry, Japan), Vol. 43, No. 6 (“Denki Enerugi Wo Riyosuru Yuki Gosei” Tokushu-go (Special Issue “Organic Synthesis Utilizing Electrical Energy”)) (1985) can appropriately be selected and used, based on properties of the compound capable of reversibly changing color via electrochemical redox reaction.

Preferable promoters usable for the present invention include, for example, the following compounds.

1) Compounds having an N—O bond, represented by TEMPO (2,2,6,6-tetramethylpiperidinyl-N-oxyl) such as N-oxyl derivatives, N-hydroxyphthalimide derivatives, or hydroxamic acid derivatives

2) Compounds having an allyloxy free radical in which a bulky substituent is introduced into the o-position such as a galvinoxyl free radical

3) Metallocene derivatives such as ferrocene

4) Benzyl (diphenylethanedione) derivatives

5) Tetrazolium salts/formazan derivatives

6) Azine compounds such as phenazine, phenothiazine, phenoxazine, or acridine

7) Pyridinium compounds such as viologen

In addition, as a promoter, usable are benzoquinone derivatives, hydrazyl free radical compounds such as verdazyl, thiazyl free radial compounds, hydrazone derivatives, phenylenediamine derivatives, triallylamine derivatives, tetrathiafulvalene derivatives, tetracyanoquinodimethane derivatives, or thianthrene derivatives.

In the display element of the present intention, the promoters in the categories of from 1) to 7) described above are preferable, but those in 1) are specifically preferable.

Next compounds in the category of 1) will be described in detail.

N-oxyl (referred to also as nitroxide radical) means an oxygen-centered radical generated by radically cleaving oxygen-hydrogen bond of hydroxylamine. It is known that the nitroxide radical has two reversible redox pairs as shown in the following scheme. The nitroxide radical becomes an oxoammonium cation via one-electron oxidization, which is reduced to reproduce a radical. Further, the nitroxide radical becomes an aminooxy anion via one-electron reduction, which is oxidized to produce a radical. Accordingly, the nitroxide radical can serve as a p type antipole reactant or an n type antipole reactant. Further, since the oxoammonium cation exhibits high acidity, and is capable of oxidizing a leuco dye, it serves as a mediator.

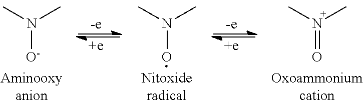

An N-oxyl derivative may be contained in an electrolyte solution, or may be immobilized on the surface of an electrode. Examples of the method of immobilizing it on the surface of an electrode include a method of introducing a group chemically or physically adsorbed onto the surface of an electrode into the N-oxyl derivative, and a method of forming a thin film on the surface of an electrode via polymerization of the N-oxyl derivative, and so forth. In addition, the N-oxyl derivative may be added in a state of an N-oxyl radical, or may be added in a state of an N-hydroxy compound, and may further be added in a state of an oxoammonium cation.

As the N-oxyl derivative, not only TEMPO (2,2,6,6-tetramethylpiperidinyl-N-oxyl), but also a derivative in which each of various substituents is substituted is commercially available. Further, in accordance with commonly known literatures, various derivatives including polymers can be easily synthesized.

Generally, when α-carbon of the nitroxide radical is substituted by hydrogen, it is known that it has been easily disproportionated to hydroxyamine and nitrone. For this reason, four merthyl groups at the α-position of the N-oxyl group in TEMPO relate to an indispensable structure existing as a stable radical, but in contrast, reactivity may often drop because of steric hindrance of these four methyl groups. An azaadamantane N-oxyl derivative or an azabicyclo N-oxyl derivative is preferable in view of no generation of activation drop thereof.

Next, an N-hydroxyphthalimide derivative, a hydroxamic acid derivative and so forth will be described. As shown in the following scheme, phthalimide N-oxyl (PINO) produced via electrode oxidization of N-hydrophthalimide (NHPI) oxidizes secondary alcohol to produce ketone. That is, it is reported that NHOI serves as an oxidization mediator (Chem. Commun., 1983, 479). As is clear from this example, it is to be understood that an oxidization-reduction pair of NHPI/PINO serves as an antipole reactant or a mediator in the display element of the present invention. An hydroxamic acid derivative and trihydroxyiminocyanuric acid (THICA) similarly to NHPI are also usable as a promoter.

When the display element of the present invention is prepared employing these compounds, adding is preferably carried out in a state of N—OH. After preparing a display element in a state of N—OH, a radical is produced via oxidization by driving the display element.

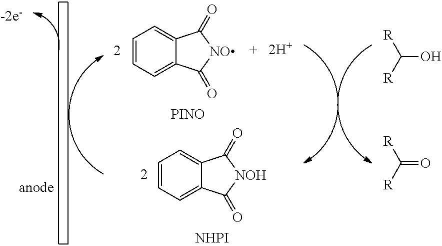

A promoter shown in the category of the above-described 1) can be represented by the following Formula (M1), and promoters represented by the following Formulae (M2)-(M6) are preferable. A polycyclic N-oxyl derivative represented by Formula (6) is specifically preferable. In addition, each kind of promoters represented by Formulae (M1)-(M5) is commercially available, and is easily acquired. Further, in accordance with commonly known literatures, each kind of derivatives can be easily synthesized. A promoter represented by Formulae (M6) can be synthesized referring to J. Am. Chem. Soc., 128, 8412 (2006) and Tetrahedron Letters 49 (2008) 48-52.

Promoters to polymerize these can be synthesized by referring to Japanese Patent O.P.I Publication No. 2004-227946, Japanese Patent O.P.I Publication No. 2004-228008, Japanese Patent O.P.I Publication No. 2006-73240, Japanese Patent O.P.I Publication No. 2007-35375, Japanese Patent O.P.I Publication No. 2007-70384, Japanese Patent O.P.I Publication No. 2007-184227, and Japanese Patent O.P.I Publication No. 2007-298713.

First, the compound represented by Formula (M1) will be described.

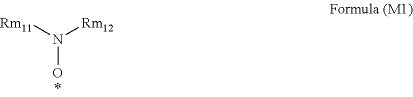

In Formula (M1) described above, each of Rm₁₁ and Rm₁₂ independently represents an aliphatic hydrocarbon group, an aromatic hydrocarbon group, a heterocyclic group, or a group connected to a nitrogen atom via >C═O, >C═S, and >C═N-Rm₁₃, which may have a substituent. Rm₁₃ represents a hydrogen atom, or an aliphatic hydrocarbon group, an aromatic hydrocarbon group or a heterocyclic group which may have a substituent. Further, Rm₁₁ and Rm₁₂ may be connected to each other to form a cyclic structure.

The aliphatic hydrocarbon group includes a chained one and a cyclic one, and the chained one includes a straight-chained one and a branched one. Examples of such an aliphatic hydrocarbon group include a methyl group, an ethyl group, a vinyl group, a propyl group, an isopropyl group, a propenyl group, a butyl group, an isobutyl group, a tert-butyl group, a pentyl group, an isopentyl group, a neopentyl group, a hexyl group, an iso-hexyl group, a cyclohexyl group, a cyclohexenyl group, an octyl group, an iso-octyl group, a cyclooctyl group, and a 2,3-dimethyl-2butyl group.

Examples of the aromatic hydrocarbon include a phenyl group and a naphthyl group. Examples of the heterocyclic group include a pyridyl group, thiazolyl group, an oxazolyl group, imidazolyl group, a furyl group, a pyrrolyl group, a pyrazinyl group, a pyrimidinyl group, a pyridazinyl group, a selenazolyl group, a sulforanyl group, a piperidinyl group, a pyrazolyl group, a tetrazolyl group, and a morpholino group.

These substituents may further have a substituent. The substituent is not specifically limited, and examples thereof include an alkyl group (for example, a methyl group, an ethyl group, a propyl group, an isopropyl group, a tert-butyl group, a pentyl group, a hexyl group, an octyl group, a dodecyl group, a tridecyl group, a tetradecyl group, a pentadecyl group, or the like), a cycloalkyl group (for example, a cyclopropyl group, a cyclopentyl group, a cyclohexyl group, or the like), an alkenyl group (for example, a vinyl group, an allyl group, a butenyl group, an octenyl group, or like), a cyclo alkenyl group (for example, a 2-cyclopentene-1-yl group, a 2-cyclohexene-1-yl group, or the like), an alkynyl group (for example, a propargyl group, an ethynyl group, a trimethylsilylethynyl group, or the like), an aryl group (for example, a phenyl group, a naphthyl group, a p-tolyl group, an m-chlorophenyl group, an o-hexadecanoylaminophenyl group, or the like), a heterocycle group (for example, a pyridyl group, a thiazolyl group, an oxazolyl group, an imidazolyl group, a furil group, a pyrrolyl group, a pyrazinyl group, a pyrimidinyl group, a pyridazinyl group, a selenazolyl group, a sulforanyl group, a piperidinyl group, a pyrazolyl group, a tetrazolyl group, a morpholino group, or the like), a heterocyclicoxy group (for example, a 1-phenyltetrazole-5-oxy group, a 2-tetrahydropyranyloxy group, a pyridyloxy group, a thiazolyloxy group, an oxazolyloxy group, an imidazolyloxy group, or the like), a halogen atom (for example, a chlorine atom, a bromine atom, iodine atoms, a fluorine atom, or the like), an alkoxy group (for example, a methoxy group, an ethoxy group, a propyloxy group, a tert-butoxy group, a pentyloxy group, a hexyloxy group, an octyloxy group, a dodecyloxy group, or the like), a cycloalkoxy group (for example, a cyclopentyloxy group, a cyclohexyloxy group, or the like), an aryloxy group (for example, a phenoxy group, a 2-naphthyloxy group, a 2-methylphenoxy group, a 4-tert-butylphenoxy group, a 3-nitrophenoxy group, a 2-tetradecanoylaminophenoxy group, or the like), an alkylthio group (for example, a methylthio group, an ethylthio group, a propylthio group, a pentylthio group, a hexylthio group, an octylthio group, a dodecylthio group, or the like), a cycloalkylthio group (for example, a cyclopentylthio group, a cyclohexylthio group, or the like), an arylthio group (for example, a phenylthio group, a 1-naphthylthio group, or the like), a heterocyclic thio group (for example, a pyridylthio group, a thiazolylthio group, an oxazolylthio group, an imidazolylthio group, a furilthio group, a pyrrolylthio group, or the like), an alkoxycarbonyl group (for example, a methoxycarbonyl group, an ethoxycarbonyl group, a butoxycarbonyl group, an octyloxycarbonyl group, a dodecyloxycarbonyl group, or the like), an aryloxycarbonyl group (for example, a phenyloxycarbonyl group, a naphthyloxycarbonyl group, or the like), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, a 2-pyridylaminosulfonyl group, a morpholinosulfonyl group, a pyrrolidinosulfonyl group, or the like), a ureido group (for example, a methylureido group, an ethylureido group, a pentylureido group, a cyclohexylureido group, an octylureido group, a dodecylureido group, a phenylureido group, a naphthylureido group, a 2-pyridylaminoureido group, or the like), an acyl group (for example, an acetyl group, an ethyl carbonyl group, and a propylcarbonyl group, a pentylcarbonyl group, a cyclohexylcarbonyl group, an octylcarbonyl group, a 2-ethylhexylcarbonyl group, a dodecylcarbonyl group, a phenylcarbonyl group, a naphthylcarbonyl group, a pyridylcarbonyl group, or the like), an acyloxy group (for example, a formyloxy group, an acetyloxy group, a pivaloyl oxy group, a stearoyloxy group, a benzoyloxy group, a p-methoxyphenylcarbonyloxy group, an ethylcarbonyloxy group, a butylcarbonyloxy group, an octylcarbonyloxy group, a dodecylcarbonyloxy group, a phenylcarbonyloxy group, or the like), an acylamino group (for example, an acetylamino group, a benzoylamino group, a formylamino group, a pivaloylamino group, a lauroylamino group, a 3,4,5-tri-n-octyloxyphenylcarbonylamino group, or the like), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, a 2-pyridylaminocarbonyl group, a morpholinocarbonyl group, a piperazinocarbonyl group, or the like), an alkanesulfinyl group or an arylsulfinyl group (for example, a methanesulfinyl group, an ethanesulfinyl group, a butanesulfinyl group, a cyclohexanesulfinyl group, a 2-ethylhexanesulfinyl group, a dodecanesulfinyl group, a phenylsulfinyl group, a naphthylsulfinyl group, a 2-pyridylsulfinyl group, or the like), an alkanesulfonyl group or an arylsulfonyl group (for example, a methanesulfonyl group, an ethanesulfonyl group, a butanesulfonyl group, a cyclohexanesulfonyl group, a 2-ethylhexanesulfonyl group, a dodecanesulfonyl group, a phenylsulfonyl group, a naphthylsulfonyl group, a 2-pyridyl sulfonyl group, or the like), an amino group (for example, an amino group, a methylamino group, an ethylamino group, a dimethylamino group, a butylamino group, a cyclopentylamino group, a 2-ethylhexylamino group, a dodecylamino group, an anilino group, an N-methylanilino group, a diphenylamino group, a naphthylamino group, a 2-pyridyl amino group, or the like), a silyloxy group (for example, a trimethylsilyloxy group, a tert-butyldimethylsilyloxy group, or the like), an amino carbonyloxy group (for example, an N,N-dimethylcarbamoyloxy group, an N,N-diethylcarbamoyloxy group, a morpholinocarbonyloxy group, an N,N-di-n-octylaminocarbonyloxy group, a N-n-octylcarbamoyloxy group, or the like), an alkoxycarbonyloxy group (for example, a methoxycarbonyloxy group, an ethoxycarbonyloxy group, a tert-butoxycarbonyloxy group, an n-octylcarbonyloxy group, or the like), an aryloxycarbonyloxy group (for example, a phenoxycarbonyloxy group, a p-methoxyphenoxycarbonyloxy group, a p-n-hexadecyloxyphenoxycarbonyloxy group, or the like), an alkoxycarbonylamino group (for example, a methoxycarbonylamino group, an ethoxycarbonylamino group, a tert-butoxycarbonylamino group, an n-octadecyloxycarbonylamino group, an N-methyl-methoxycarbonylamino group, or the like), an aryloxycarbonylamino group (for example, a phenoxycarbonylamino group, a p-chlorophenoxycarbonylamino group, an m-n-octyloxyphenoxycarbonylamino group, or the like), a sulfamoylamino group (for example, a sulfamoylamino group, an N,N-dimethylaminosulfonylamino group, an N-n-octylaminosulfonylamino group, or the like), a mercapto group, an arylazo group (for example, a phenylazo group, a naphthylazo group, a p-chlorophenylazo group, or the like), a heterocyclic azo group (for example, a pyridylazo group, a thiazolylazo group, an oxazolylazo group, an imidazolylazo group, a furilazo group, a pyrrolylazo group, a 5-ethylthio-1,3,4-thiadiazole-2-ylazo group, or the like), an imino group (for example, an N-succinimide-1-yl group, an N-phthalimide-1-yl group, or the like), a phosphino group (for example, a dimethylphosphino group, a diphenylphosphino group, a methylphenoxyphosphino group, or the like), a phosphinyl group (for example, a phosphinyl group, a dioctyloxyphosphinyl group, a diethoxyphosphinyl group, or the like), a phosphinyloxy group (for example, a diphenoxyphosphinyloxy group, a dioctyloxyphosphinyloxy group, or the like), a phosphinylamino group (for example, a dimethoxyphosphinylamino group, a dimethylaminophosphinylamino group, or the like), a silyl group (for example, a trimethylsilyl group, a tert-butyldimethylsilyl group, a phenyldimethylsilyl group, or the like), a cyano group, a nitro group, a hydroxyl group, a sulfo group, a carboxyl group, and so forth.

The compound represented by Formula (M1) may be a multimer such as a dimmer, a trimer or the like connected by the foregoing substituent, or may also be a polymer.

Next, the compound represented by Formula (M2) will be described.

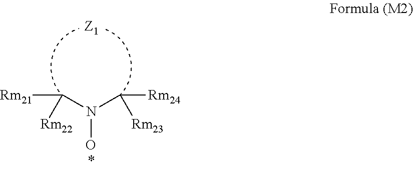

In Formula (M2) described above, each of Rm₂₁, Rm₂₂, Rm₂₃ and Rm₂₄ independently represents an aliphatic hydrocarbon group, an aromatic hydrocarbon group or a heterocyclic group which may have a hydrogen atom or a substituent. These aliphatic hydrocarbon group, aromatic hydrocarbon group and heterocyclic group are synonymous with those shown in foregoing Formula (M1).

Z₁ represents a group of atoms to form a cyclic structure, and preferably forms a 5-membered ring or a 6-membered ring. Z₁ may further have a substituent, and as a substituent thereof, provided is the same substituent as represented by foregoing Formula (M1). Atoms constituting Rm₂₁-Rm₂₄ and Z₁ may be connected to each other to form a cyclic structure, and for example, a polycyclic structure together with nitrogen atoms such as an azanorbornene structure, an azaadamantane structure or the like may be formed.

As a cyclic structure of the compound represented by Formula (M2), preferable is a piperidine ring, a pyrrolidine ring or an azaadamantane ring.

Next, the compound represented by Formula (M3) will be described.

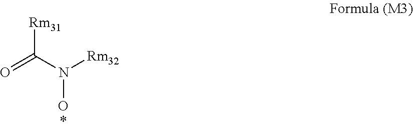

In Formula (M3) described above, Rm₃₁ represents an aliphatic hydrocarbon group, an aromatic hydrocarbon group or a heterocyclic group, which may a substituent substituted by a carbonyl carbon atom directly or via an oxygen atom, a nitrogen atom and a sulfur atom. Rm₃₂ represents an aliphatic hydrocarbon group, an aromatic hydrocarbon group or a heterocyclic group which may have a substituent. These aliphatic hydrocarbon group, aromatic hydrocarbon group and heterocyclic group are synonymous with those shown in foregoing Formula (M1). Rm₃₁ and Rm₃₂ may be connected to each other to form a cyclic structure.

In Formula (M3), Rm₃₂ is preferably an aromatic hydrocarbon group, but a phenyl group which may have a substituent is specifically preferable. As a substituent in the phenyl group, preferable is an electron withdrawing group such as a cyano group, an alkoxycarbonyl group, a trifluoromethyl group or the like. As Rm₃₁, preferable is a phenyl group or an aliphatic hydrocarbon group directly connected to a carbonyl carbon atom, and a branched alkyl group and a cycloalkyl group are specifically preferable. In addition, the compound represented by Formula (M3) is preferably added in a state of N—OH to form a display element.

Next, the compound represented by Formula (M4) will be described.

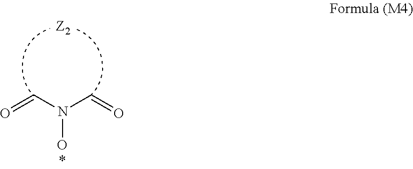

In Formula (M4) described above, Z₂ represents a group of atoms to form a cyclic structure, and preferably forms a 5-membered ring or a 6-membered ring. Z₂ may further have a substituent, and as a substituent thereof, provided is the substituent shown in Formula (M1). Further, Z₂ may be a condensed ring. In addition, the compound represented by Formula (M4) is preferably added in a state of N—OH to form a display element.

Next, the compound represented by Formula (M5) will be described.

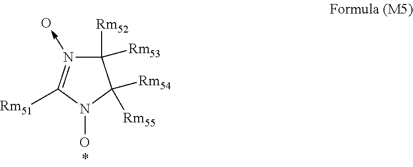

In Formula (M5) described above, each of Rm₅₁-Rm₅₅ independently represents an aliphatic hydrocarbon group, an aromatic hydrocarbon group or a heterocyclic group which may have a substituent. These aliphatic hydrocarbon group, aromatic hydrocarbon group and heterocyclic group are synonymous with those shown in foregoing Formula (M1).

In Formula (M5), Rm₅₁ is preferably an aromatic hydrocarbon group, but a phenyl group which may have a substituent is specifically preferable. As a substituent in the phenyl group, preferable is an electron withdrawing group such as a cyano group, an alkoxycarbonyl group, a trifluoromethyl group or the like. Each of Rm₅₂-Rm₅₅ preferably an alkyl group having 1-6 carbon atoms, and a methyl group is specifically preferable.

Next, the compound represented by Formula (M5) will be described.

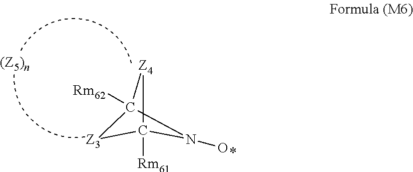

In Formula (M6) described above, Rm₆₁ and Rm₆₂ independently represents an aliphatic hydrocarbon group which may have a hydrogen atom or a substituent. Each of Rm₆₁ and Rm₆₂ is preferably a hydrogen atom or a straight-chain alkyl group having not more than 4 atoms, and at least one of Rm₆₁ and Rm₆₂ is preferably a hydrogen atom.

Each of Z₃, Z₄ and Z₅ represents a group of atoms to form a cyclic structure (for example, carbon, nitrogen, oxygen, sulfur or the like), and preferably forms a 5-membered ring or a 6-membered ring. Each of Z₃, Z₄ and Z₅ may further have a substituent.

Numeral n is 0 or 1, but when n=0, Formula (M6) represents a bicyclo compound, and when n=1, Formula (M6) represents a tricyclo compound.

As a compound represented by Formula (M6), numeral n is preferably 0, and an azaadamantane derivative is specifically preferable.

Specific examples of promoters usable in the present invention are shown below, but the present invention is not limited thereto.

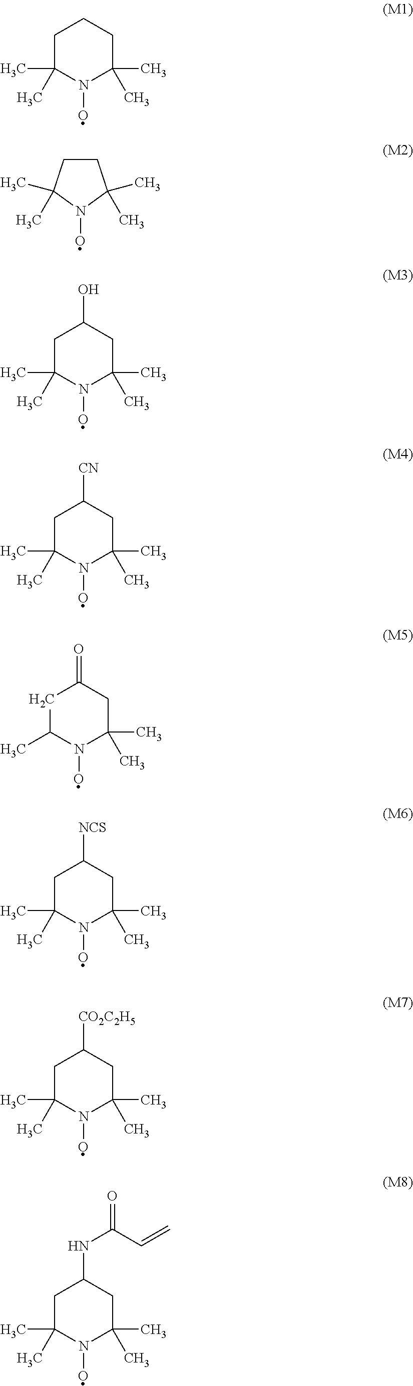

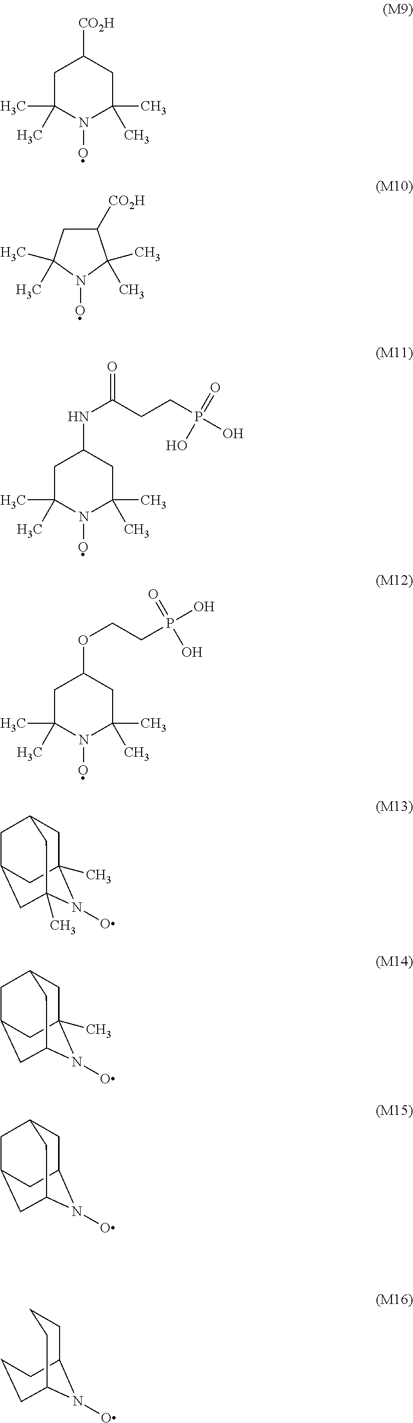

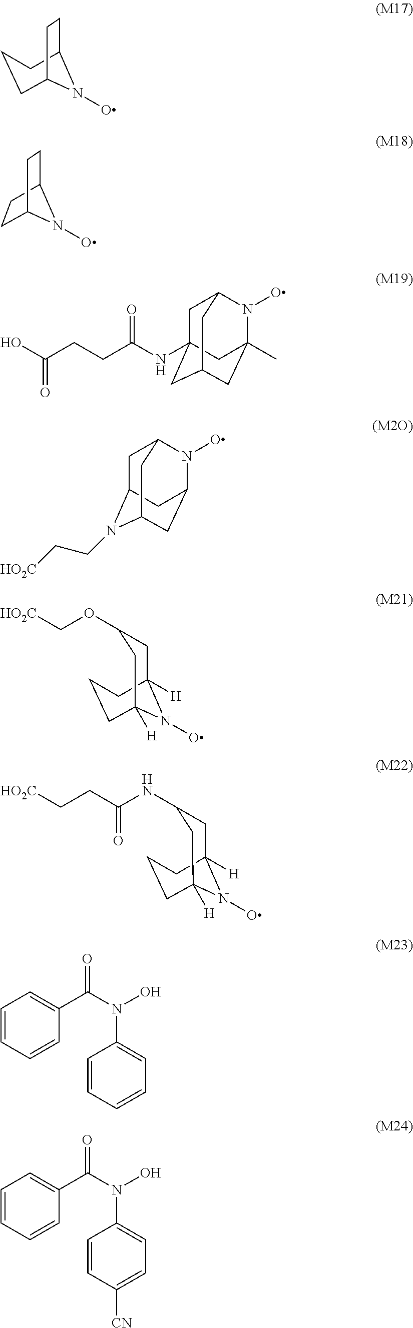

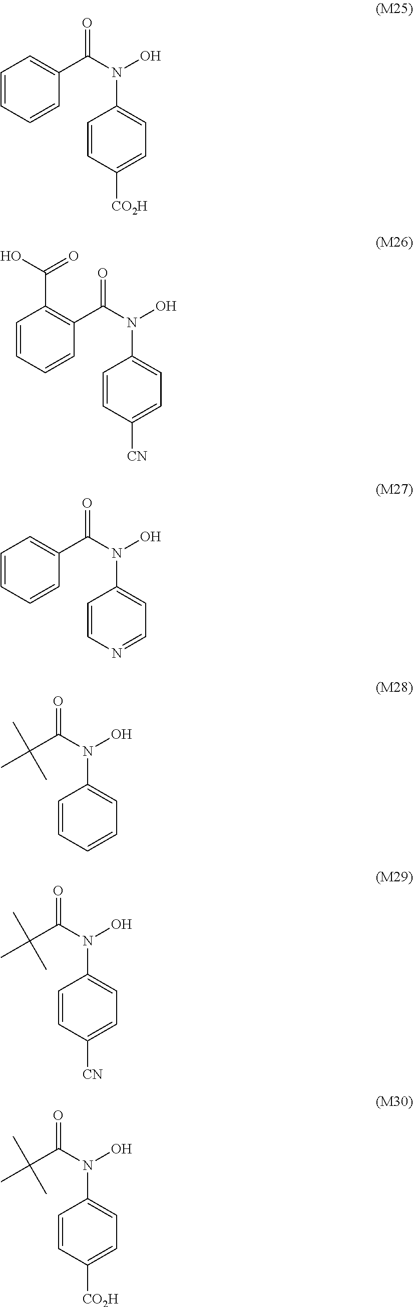

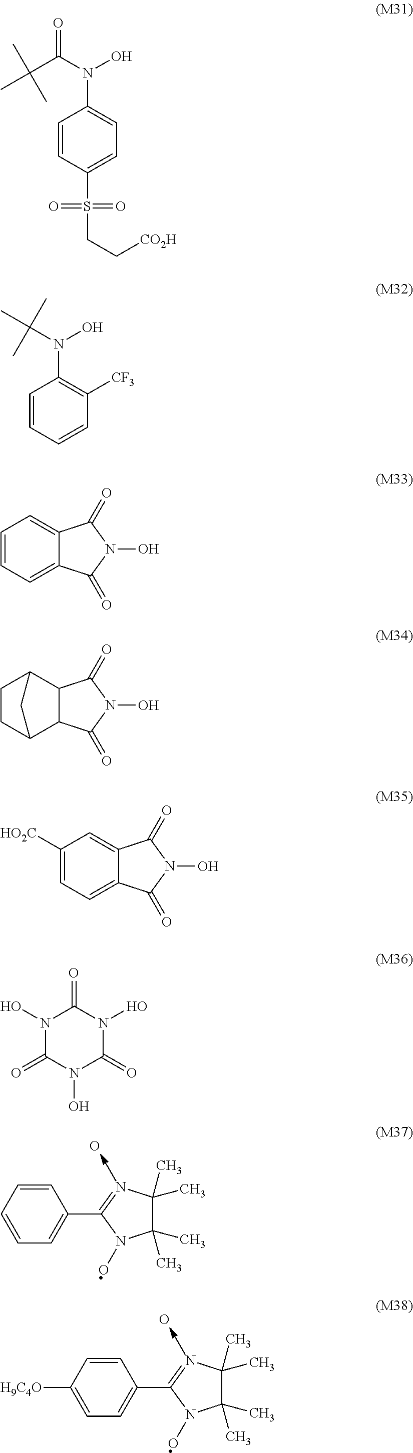

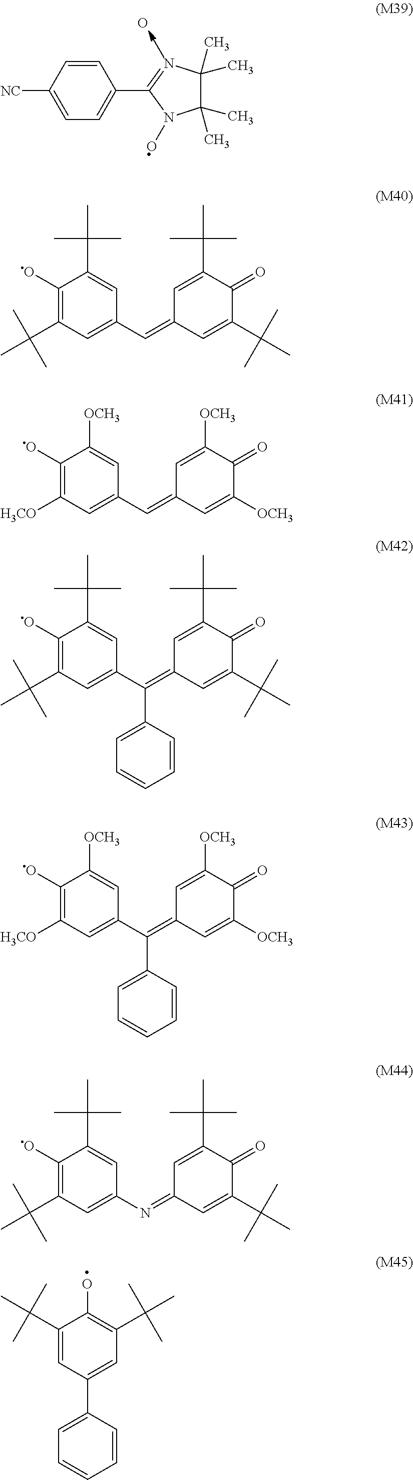

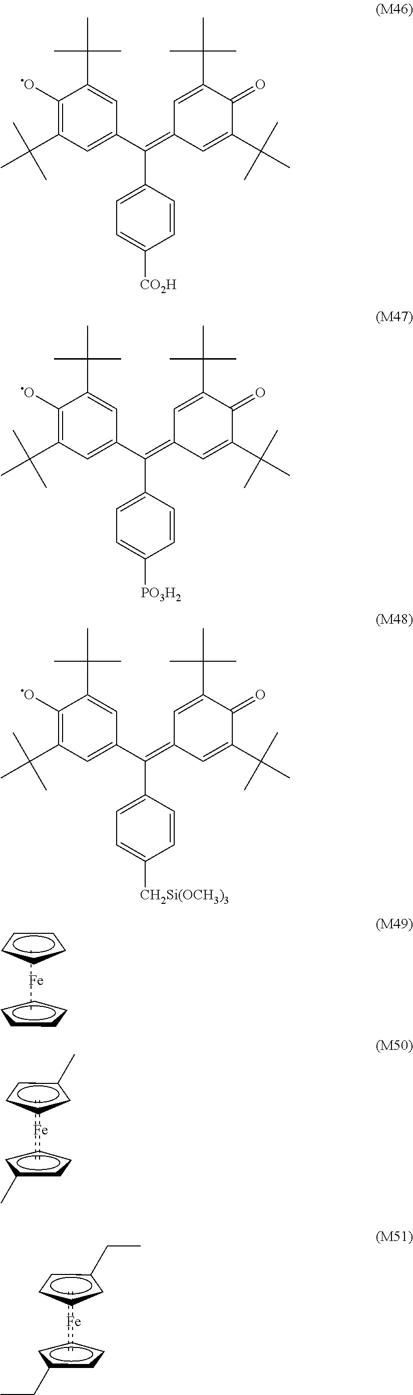

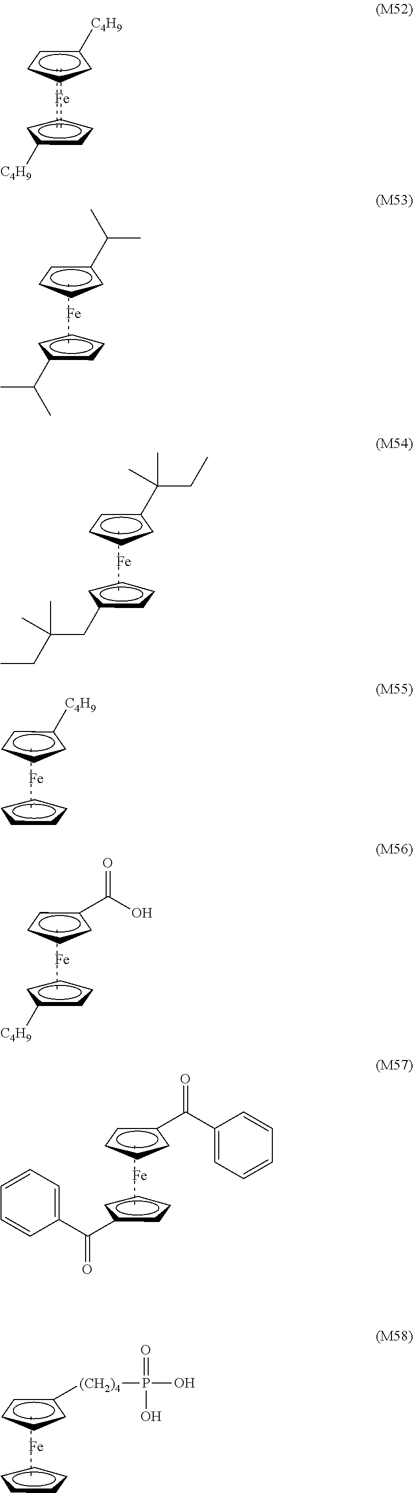

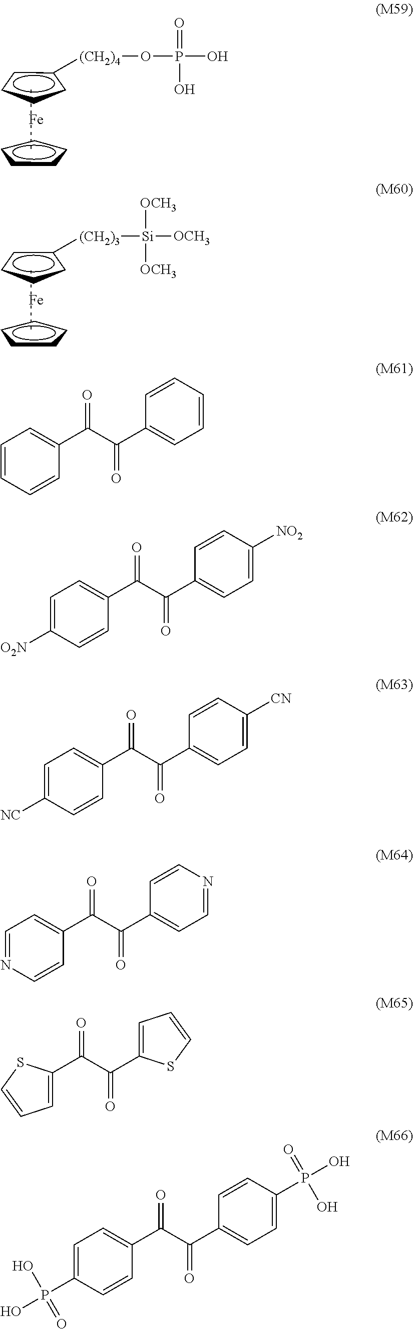

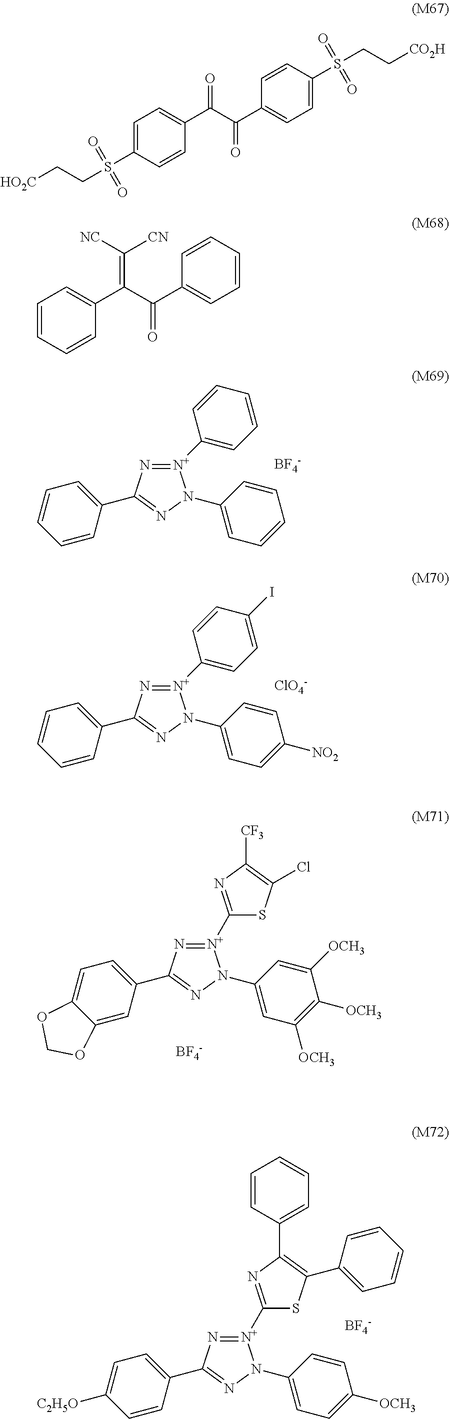

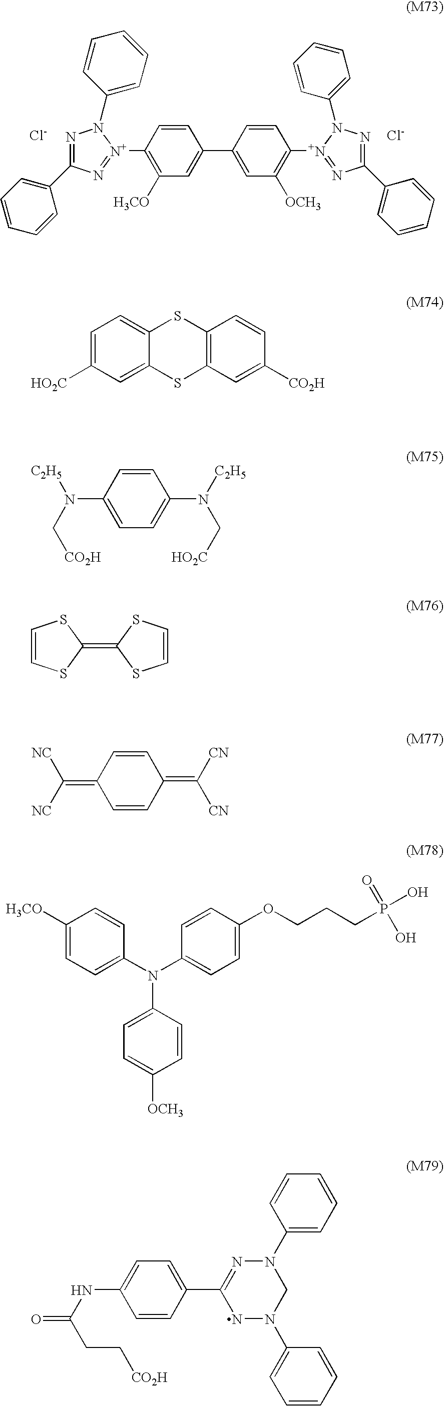

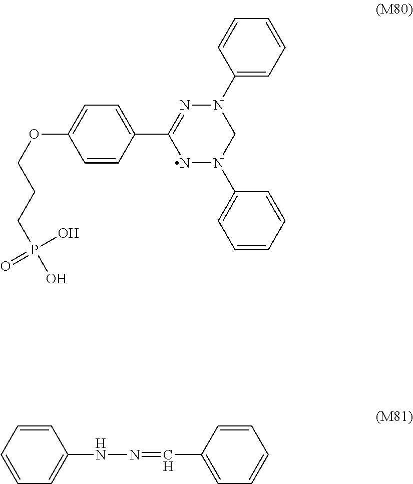

### [Electron Insulation Layer]

In a display element of the present invention, an electron insulation layer can be provided.

The electron insulation layer applicable to the present invention may be a layer exhibiting ion conductivity together with electron insulation Examples thereof include a solid electrolyte film for which a polymer or a salt having a polar group is prepared in the form of a film, a quasi-solid electrolyte film in which an electrolyte is supported in a porous film with high electron insulation and its pores, a polymer porous film having pores, and a porous body made of an inorganic material exhibiting low specific permittivity such as a silicon-containing compound.

As a method of forming a porous film, there can be used any of commonly known formation methods such as a firing method (a fusion method) (polymer fine particles or inorganic particles are added to a binder and partially fused, and then pores having been generated among particles are utilized), an extraction method (a constituent layer is formed of an organic or inorganic substance soluble in a solvent and a binder insoluble in the solvent, and then the organic or inorganic substance is dissolved with the solvent to obtain fine pores), a foaming method in which a polymer is allowed to foam by heating or degassing, a phase conversion method in which a mixture of polymers is phase-separated via manipulation of a good solvent and a poor solvent, or a radiation irradiation method to form fine pores via irradiation of various kinds of radiations. Specifically, there are listed electron insulation layers described in Japanese Patent O.P.I. Publication No. 10-30181 and Japanese Patent O.P.I. Publication No. 2003-107626, Japanese Patent Examined Publication No. 7-95403, Japanese Patent Publication No. 2635715, Japanese Patent Publication No. 2849523, Japanese Patent Publication No. 2987474, Japanese Patent Publication No. 3066426, Japanese Patent Publication No. 3464513, Japanese Patent Publication No. 3483644, Japanese Patent Publication No. 3535942, and Japanese Patent Publication No. 3062203.

### [Others]

Various additives are usable for an electrolyte in a display element prepared by a method of manufacturing the display element of the present invention in order to improve various other properties. They are selected depending on the purpose, and are not specifically limited.

Chemical sensitizers, noble metal sensitizers, photosensitive dyes, supersensitizers, high boiling point solvents, antifoggants, stabilizers, development inhibitors, bleach promoters, fixing promoters, color mixing inhibitors, formalin scavengers, toners, hardeners, surface active agents, thickening agents, plasticizers, lubricants, UV absorbents, anti-irradiation dyes, filter light absorbing dyes, fungicides, polymer latexes, heavy metals, antistatic agents and matting agents are usable, if desired.

The additives described above are detailed in Research Disclosure (hereinafter denoted simply as RD) Volume 176 Item/17643 (December 1978), RD Volume 184 Item/18431 (August 1979), RD Volume 187 Item/18716 (November 1979), and RD Volume 308 Item/308119 (December 1989).

Kinds of compounds and sections thereof disclosed in these 3 Research-Disclosures are shown in the following Table 1.

TABLE 1

| | Additives | | | | |
|---|---|---|---|---|---|
| | RD 17643 | | RD 18716 | RD 308119 | |
| Items | Page | Section | Page | Page | Section |
| Chemical | 23 | III | 648 right top | 996 | III |
| sensitizer | | | | | |
| Sensitizing dye | 23 | IV | 648, 649 | 996-998 | IV |
| Desensitizing | 23 | IV | — | 998 | IV |
| dye | | | | | |
| Dye | 25, 26 | VIII | 649, 650 | 1003 | VIII |
| Development | 29 | XXI | 648 right top | — | — |
| promoter | | | | | |
| Antifoggant | 24 | IV | 649 right top | 1006, 1007 | VI |
| stabilizer | | | | | |
| Optical | 24 | VIII | — | 998 | V |
| brightening | | | | | |
| agent | | | | | |
| Hardener | 26 | XXI | 651 left | 1004, 1005 | X |
| Surfactant | 26, 27 | XI | 650 right | 1005, 1006 | XI |
| Antistatic agent | 27 | XII | 650 right | 1006, 1007 | XIII |
| Plasticizer | 27 | XII | 650 right | 1006 | XII |
| Lubricant | 27 | XII | — | — | — |
| Matting agent | 28 | XVI | 650 right | 1008, 1009 | XVI |
| Binder | 26 | XXII | — | 1003, 1004 | IX |
| Support | 28 | XVII | — | 1009 | XVII |

An auxiliary layer such as a protective layer, a filter layer, an antihalation layer, a crossover light cutting layer, a backing layer is formed, and the above-described additives are possible to be contained in the auxiliary layer.

### [Substrate]

The substrate used in the present invention are preferably a transparent substrate. As such a transparent substrate, preferably usable are a polymer film made of polyester (for example, polyethylene terephthalate ans so forth), polyimide, methyl polymethacrylate, polystyrene, polypropylene, polyethylene, polyamide, nylon, polyvinyl chloride, polyvinylidene chloride, polycarbonate, polyether sulfone, a silicon resin, a polyacetal resin, a fluorine resin, a cellulose derivative or polyolefin; a plate substrate; a glass substrate: and so forth. The transparent substrate used in the present invention means a substrate exhibiting a transmittance of 50% or more with respect to visible light.

Further, an opaque substrate such as an inorganic substrate (for example, a metal substrate, a ceramic substrate and so forth) is usable for facing substrates.

### [Other Constituent Elements of Display Element]

The display element of the present invention may optionally employ sealing agents, column-structure materials, and spacer particles.

### (Sealing Agent)

Sealing agents are those to seal materials so that they do not leak out, and also called sealers. Usable are curing type, thermosetting type, photo-curing type, moisture curing type, and anaerobic curing type such as epoxy resins, urethane resins, acryl resins, vinyl acetate resins, ene-thiol resins, silicone resins, or modified polymer resins.

### (Columnar Structure Material)

Columnar structure materials provide strong self-supporting (strength) between substrates. Examples thereof include a cylindrical form, a quadrangular form, an elliptic cylindrical form and a trapezoidal form, which are arranged at definite intervals in a specified pattern such as a lattice. Further, there may be employed stripe-shaped ones arranged at definite intervals. It is preferable that the columnar structure materials are not randomly arranged, but arranged at equal intervals, arranged so as to vary the interval gradually, or arranged so as to repeat a predetermined pattern at a definite cycle so that the distance between substrates is appropriately maintained and image display is not hindered. When 1-40% of the display region of a display element is occupied by the columnar structure material, sufficient strength for commercial viability is achieved for a display element.

### (Spacer)

There may be provided a spacer between a pair of substrates to maintain a uniform gap between them. Examples of such a spacer include a spherical material composed of a resins or inorganic oxide. Further, adhesion spacers are suitably employed the surface of which is coated with thermoplastic resins. In order to maintain the uniform gap between substrates, there may be provided only columnar structure materials. However, there may be provided both spacers and columnar structure materials. In place of the columnar structure materials, only spacers may be employed as a space-holding member. The diameter of spacers, when a columnar structure material is formed, is not more than its height, and is preferably equal to the height. When no columnar structure material is formed, the diameter of spacers corresponds to the thickness of the cell gap.

### [Method of Driving Display Element]

A driving operation of the display element of the present invention may be a simple matrix drive or active matrix drive. The simple matrix drive referred to in the present invention refers to a driving method in which electrical current is sequentially applied to a circuit formed by vertically crossing of a positive line containing plural positive electrodes to a facing negative line containing plural negative electrodes. The use of such a simple matrix drive has the advantage that the circuit structure and the driving IC are capable of being simplified to reduce the production cost. The active matrix drive refers to a driving method using TFT circuits in which scanning lines, data lines, and current supplying lines are formed in a grid manner and the TFT circuits are positioned in each of the grids. The active matrix drive is advantageous in gradation and memory functions since a switching function can be allocated to each pixel. The circuit described, for example, in FIG. 5 of Japanese Patent O.P.I. Publication No. 2004-29327 is employable.

### (Deposition Overvoltage Control: Blackened Silver)

As to a display element of the present invention, it is preferred to conduct driving operation for black display by continuously depositing blackened silver via application of voltage lower than deposition overvoltage after depositing the blackened silver via application of voltage higher than the deposition overvoltage. Performing such the driving operation results in reduction in writing energy, reduced load of the drive circuit and enhanced writing speed with respect to the image plane. Existence of overvoltage in the electrode reaction is generally known in the field, of electrochemistry. The overvoltage is detailed in, for example, “Chemistry of Electron Transfer/Introduction of Electrochemistry” (1996, published by Asakura Shoten) on page 121. The electrochemical display element of the present invention is regarded as an electrode reaction of an electrode and silver within electrolyte so that existence of an overvoltage in dissolution and deposition of silver is readily understand.

### (Deposition Overvoltage Control: SECD)

A controlling method of a transparent state and a colored state of the display element in the present invention is preferably determined based on the redox potential of an electrochromic compound, and deposition overvoltage of a metal compound.

For example, when a display element has an electrochromic compound and a metal compound between facing electrodes, a colored state other than black is expressed on the oxidation side and a black state is expressed on the reduction side. As one example of a controlling method in this case, there is exemplified a method in which a voltage higher than the redox potential of an electrochromic compound is applied and then the electrochromic compound is oxidized to express a colored state other than black; a voltage somewhere between the redox potential of the electrochromic compound and the deposition overvoltage of a metal compound is applied and then the electrochromic compound is reduced to return to a white state; a voltage lower than the deposition overvoltage of the metal compound is applied and then a metal is deposited on the electrode to express a black state; and a voltage somewhere between the oxidation potential of the deposited metal and the redox potential of the electrochromic compound is applied and then the deposited metal is dissolved for decoloration.

### (Application to Products)

The display element prepared by a method of manufacturing a display element of the present invention is applied to fields including electronically published books, ID cards, public use, transportation, broadcasting, financial clearance, and distribution and logistics. Specific examples thereof include door keys, student ID cards, employee ID cards, various membership cards, convenience store cards, department store cards, vending machine cards, gas station cards, subway and railroad cards, bus cards, cashing cards, credit cards, highway cards, driver's license cards, hospital consultation cards, electronic medical charts, health insurance cards, basic resident registers, passports, one time passwords, electronic books, enclosure decoration for various devices such as a cell phone cover, keyboard display, electronic shelf labels, electronic POP, electronic advertisement and so forth. Electronic books, electronic advertisement, and electronic POP for which large sized display is desired are specifically effective for production thereof.

### EXAMPLE

Next, the present invention will be described referring to examples, but the present invention is not limited thereto. Incidentally, “parts” and “%” used in EXAMPLE represent “parts by weight” and “% by weight”, respectively, unless otherwise specifically mentioned.

### Preparation of Electrolyte

### (Preparation of Electrolyte 1)

In 2.5 g of dimethyl sulfoxide, dissolved were 0.1 g of bismuth chloride, 0.2 g of lithium bromide and 0.025 g of tetrabutyl ammonium perchlorate to prepare electrolyte 1.

### (Preparation of Electrolyte 2)

In 2.5 g of dimethyl sulfoxide, dissolved were 0.1 g of silver p-toluenesulfonate and 0.025 g of tetrabutyl ammonium perchlorate to prepare electrolyte 2.

### (Preparation of Electrolyte 3)

In 2.5 g of dimethyl sulfoxide, dissolved were 0.025 g of spiro tetrafluoroborate (1,1′)-bipyrrolidinium, 0.05 g of carboxy TEMPO (4-carboxy-2,2,6,6-tetramethylpiperidine-1-oxyl free radical), 0.1 g of silver p-toluenesulfonate, and 0.2 g of 3-mercapto-1,2,4-triazole to prepare electrolyte 3.

### (Preparation of Electrolyte 4)

In 2.5 g of dimethyl sulfoxide, dissolved were 0.025 g of spiro tetrafluoroborate (1,1′)-bipyrrolidinium, 0.05 g of carboxy TEMPO (4-carboxy-2,2,6,6-tetramethylpiperidine-1-oxyl free radical), 0.1 g of silver p-toluenesulfonate, and 0.2 g of 3,6-dithia-1,8-octanediol to prepare electrolyte 4.

(Preparation of Electrolyte 5)

In 2.5 g of 2-methoxyethanol, dissolved were 0.5 g of heptylviologen and 0.0025 g of nitric acid to prepare electrolyte 5.

### (Preparation of Electrolyte 6)

In 2.5 g of dimethyl sulfoxide, dissolved were 0.005 g of exemplified compound (L68), 0.025 g of spiro tetrafluoroborate (1,1′)-bipyrrolidinium and 0.05 g of carboxy TEMPO (4-carboxy-2,2,6,6-tetramethylpiperidine-1-oxyl free radical) to prepare electrolyte 6.

### (Preparation of Electrolyte 7)

In 2.5 g of dimethyl sulfoxide, dissolved were 0.025 g of spiro tetrafluoroborate (1,1′)-bipyrrolidinium and 0.05 g of carboxy TEMPO (4-carboxy-2,2,6,6-tetramethylpiperidine-1-oxyl free radical) to prepare electrolyte 7.

### Preparation of Electrode

### (Preparation of Electrode 1)

An ITO (Indium Tin Oxide) film having a pitch of 145 μm and a width of 130 μm was formed as an electrically conductive layer on a 2 cm×4 cm glass substrate having a thickness of 1.5 mm by a commonly known method to prepare electrode 1.

### (Preparation of Electrode 2)

Paste liquid containing titanium dioxide particles having an average particle diameter of 10 nm was coated on electrode 1 prepared above by a screen printing method, and a solvent was removed from the paste liquid by heating at 150° C. for 30 minutes to prepare electrode 2 in which a nanoporous layer of titanium dioxide having a thickness of 1 μm was formed.

### (Preparation of Electrode 3)

A precipitate deposited by adding hydrogen peroxide water into an aqueous tin (II) fluoride solution was collected, followed by drying, and electrode 2 prepared above was vertically suspended, and immersed in a treatment solution in which a solution prepared by dissolving the dried in a 55% hydrofluoric acid (0.1 mol/L), and an aqueous boric acid solution (0.2 mol/L) were mixed in equal amount at room temperature for 30 minutes. Then, it was lifted, and subsequently washed with pure water, followed by drying at 85° C. for one hour to prepare electrode 3.

### (Preparation of Electrode 4)

Electrode 2 prepared above was vertically suspended, and immersed in a treatment solution in which an aqueous ammonium fluorosilicate solution (0.1 mol/L) and an aqueous boric acid solution (0.2 mol/L) were mixed in equal amount at room temperature for 30 minutes. Then, it was lifted, and subsequently washed with water, followed by drying at 85° C. for one hour to prepare electrode 4.

### (Preparation of Electrode 5)

Electrode 2 prepared above was vertically suspended, and immersed in a treatment solution in which an aqueous ammonium fluorotitanate solution (0.1 mol/L) and an aqueous boric acid solution (02 mol/L) were mixed in equal amount at room temperature for 30 minutes. Then, it was lifted, and subsequently washed with water, followed by drying at 85° C. for one hour to prepare electrode 5.

### (Preparation of Electrode 6)

After electrode 5 was immersed in the following treatment solution 1, and left standing at room temperature for about one hour, it was washed with water, followed by heating at 100° C. for about one hour, and subsequently was cooled. Next, the following treatment solution 2 in an amount of approximately 100 mg/cm² was placed on a titanium dioxide layer, and the system was left standing at room temperature for about 3 hours, followed by washing with ethanol and water to prepare electrode 6.

### <Preparation of Treatment Solution 1>

In 20 g of water, dropped were 0.1 g of 3-aminopropyltrimethoxysilane while stirring, and the system was stirred at room temperature for about one hour to prepare treatment solution 1.

### <Preparation of Treatment Solution 2>

In 1 g of dimethylformamide, dissolved were 0.025 g of exemplified compound (L1) and 0.032 g of 1-rthyl-3-(3-dimethylaminopropyl)carbodiimide hydrochloride to prepare treatment solution 2.

### (Preparation of Electrode 7)

The following treatment solution 3 in an amount of approximately 100 mg/cm² was placed on a titanium dioxide layer of electrode 5, and the system was left standing at room temperature for about 1 hours, followed by washing with ethanol and water, and subsequently heated at 100° C. for about one hour to prepare electrode 7.

### <Preparation of Treatment Solution 3>

In 0.02 g of acetic acid, 1 g of pure water and 1 g of methanol which were stirred, dropped were a solution in which 0.01 g of exemplified compound (L25) was dissolved in 0.15 g of methanol while stirring, and the system was stirred at room temperature for about one hour to prepare treatment solution 4.

### (Preparation of Electrode 8)

A nickel electrode having an electrode thickness of 0.1 μm, a pitch of 145 μm and an electrode interval of 130 μm was formed on a 2 cm×4 cm glass substrate having a thickness of 1.5 mm by a commonly known method, and the resulting electrode was further immersed in an immersion gold plating solution to prepare a gold-nickel electrode (electrode 8) substituted by gold from the electrode surface up to a depth of 0.05 μm.

### (Preparation of Electrode 9)

After KRARAY POVAL PVA235 (a polyvinyl alcohol resin, produced by KRARAY CO. LTD.) was added into a water/ethanol mixture solution so as to achieve 2% in terms of solid content, and was dissolved while heating, a titanium dioxide dispersion obtained by dispersing titanium dioxide CR-90 (produced by ISHIHARA SANGYO KAISHA LTD.) with an ultrasonic homogenizer so as to give 20% was screen-printed on electrode 12 prepared so as to give a dry average film thickness of 20 μm. Thereafter, drying was conducted at 50° C. for 30 minutes to vaporize a solvent, and drying was subsequently carried out at 85° C. for one hour to prepare electrode 9 in which a porous white scattering layer was formed.

### (Preparation of Electrode 10)

Electrode 10 was prepared similarly to preparation of electrode 3, except that electrode 2 was replaced by electrode 9.

### (Preparation of Electrode 11)

Electrode 11 was prepared similarly to preparation of electrode 4, except that electrode 2 was replaced by electrode 9.

### (Preparation of Electrode 12)

Electrode 12 was prepared similarly to preparation of electrode 5, except that electrode 2 was replaced by electrode 9.

### Preparation of Display Element

### [Preparation of Display Element 1: Present Invention]

An electrode 10 periphery was rimmed with an olefin based sealant containing 10% of glass-made spherical beads having an average particle diameter of 40 μm as a volume fraction, and electrode 10 and electrode 1 as electrodes in the form of a stripe were subsequently attached so as to be normal to each other to prepare an empty cell further via heat-pressing. Electrolyte 1 was vacuum-injected into the empty cell, and the inlet was sealed with a UV curable epoxy based resin to prepare display element 1.

### (Preparation of Display Element 2: Present Invention)

Display element 2 was prepared similarly to preparation of display element 1, except that electrode 10 was replaced by electrode 11.

### (Preparation of Display Elements 3-5: Present Invention)

Display elements 3-5 were prepared similarly to preparation of display element 2, except that electrode 1 was replaced by electrodes 2-4, respectively.

### (Preparation of Display Element 6: Comparative Example)

Display element 6 was prepared similarly to preparation of display element 1, except that electrode 10 was replaced by electrode 9.

### (Preparation of Display Element 7: Present Invention)

Display element 7 was prepared similarly to preparation of display element 1, except that electrode 1 was replaced by electrode 2, and electrolyte 1 was replaced by electrolyte 5.

### (Preparation of Display Element 8: Present Invention)

Display element 8 was prepared similarly to preparation of display element 7, except that electrode 2 was replaced by electrode 3.

### (Preparation of Display Element 9: Present Invention)

Display element 9 was prepared similarly to preparation of display element 8, except that electrode 3 was replaced by electrode 4, and electrode 10 was replaced by electrode 11.

### (Preparation of Display Element 10: Present Invention)

Display element 10 was prepared similarly to preparation of display element 9, except that electrode 4 was replaced by electrode 5, and electrode 11 was replaced by electrode 12.

### (Preparation of Display Element 11: Present Invention)

Display element 11 was prepared similarly to preparation of display element 10, except that electrolyte 5 was replaced by electrolyte 6.

### (Preparation of Display Element 12: Present Invention)

Display element 12 was prepared similarly to preparation of display element 11, except that electrolyte 6 was replaced by electrolyte 7, and electrode 5 was replaced by electrode 6.

### (Preparation of Display Element 13: Present Invention)

Display element 13 was prepared similarly to preparation of display element 12, except that electrolyte 6 was replaced by electrolyte 7.

### (Preparation of Display Element 14: Comparative Example)

Display element 14 was prepared similarly to preparation of display element 7, except that electrode 10 was replaced by electrode 9.

### (Preparation of Display Element 15: Present Invention)

Display element 15 was prepared similarly to preparation of display element 4, except that electrode 1 was replaced by electrode 2, and electrode 11 was replaced by electrode 12.

### (Preparation of Display Element 16: Present Invention)

Display element 16 was prepared similarly to preparation of display element 15, except that electrode 2 was replaced by electrode 6.

### (Preparation of Display Element 17: Present Invention)

Display element 17 was prepared similarly to preparation of display element 16, except that electrolyte 3 was replaced by electrolyte 4.

### (Preparation of Display Element 18: Present Invention)

Display element 18 was prepared similarly to preparation of display element 15, except that electrode 12 was replaced by electrode 9.

### Evaluation of Display Element

### [Evaluation of Durability]

Both electrodes of each of the resulting electrochemical display elements were connected to both terminals of a constant-voltage power supply, respectively, and a voltage of −1.5 V was applied to an electrode on the display side for 1.5 seconds, and reflectance in the display section of each display element was subsequently determined with a spectrophotometer CM-3700d (manufactured by Konica Minolta Sensing, Inc.). Reflectance at a maximum absorption wavelength of λmax in the visible light region for display elements 7-14 was designated as R₍₀₋₎, and reflectance at wavelength of 550 nm for elements other than the foregoing display elements was designated as R₍₀₎. After further applying a voltage of +1.5 V to an electrode on the display side, display elements 7-14 were similarly measured, and the resulting reflectance was designated as R₍₊₎. R₍₀₋₎ or R₍₀₊₎, whichever is smaller, was designated as R₍₀₎.

Thereafter, application of a voltage of +1.5 V for 0.5 second and application of a voltage of −1.5 V for 0.5 second were set as one frequency, and repetitive voltage of a frequency of 10000 was applied to each display element. Then, measurements were carried out in the same manner as described above, and the resulting reflectances were designated as R₍₁₀₀₀₀₎, R₍₁₀₀₀₀₋₎ and R₍₁₀₀₀₀₊₎, respectively.

A change in contrast ratio before and after application of the repetitive voltage was defined as ΔR=|R₍₀₎−R₍₁₀₀₀₀₎, which was designated as an indicator of stability in reflectance during repetitively driving. The smaller the value of ΔR is, the more excellent durability in reflectance during repetitively driving.

The structure of each display element and evaluation results thereof are shown in FIG. 2.

TABLE 2

| | Structure of display element | | | | |
|---|---|---|---|---|---|
| Display | Electrode | Electrode | | Evaluation results | |
| element | on display | on nondisplay | | Durability | |
| No. | side | side | Electrolyte | ΔR (%) | Remarks |
| 1 | 1 | 10 | 1 | 17 | Present invention |
| 2 | 1 | 11 | 1 | 15 | Present invention |
| 3 | 1 | 11 | 2 | 10 | Present invention |
| 4 | 1 | 11 | 3 | 6 | Present invention |
| 5 | 1 | 11 | 4 | 6 | Present invention |
| 6 | 1 | 9 | 1 | 25 | Comparative example |
| 7 | 2 | 10 | 5 | 18 | Present invention |
| 8 | 3 | 10 | 5 | 15 | Present invention |
| 9 | 4 | 11 | 5 | 12 | Present invention |
| 10 | 5 | 12 | 5 | 12 | Present invention |
| 11 | 5 | 12 | 6 | 9 | Present invention |
| 12 | 6 | 12 | 7 | 6 | Present invention |
| 13 | 7 | 12 | 7 | 5 | Present invention |
| 14 | 2 | 9 | 5 | 23 | Comparative example |
| 15 | 2 | 12 | 3 | 9 | Present invention |
| 16 | 6 | 12 | 3 | 6 | Present invention |
| 17 | 6 | 12 | 4 | 7 | Present invention |
| 18 | 2 | 9 | 3 | 22 | Comparative example |

As is clear from Table 2, it is to be understood that display elements formed from the structure specified by the present invention exhibit superior durability to that of comparative examples.

1. A display element comprising a porous layer and an electrolyte between a pair of facing electrodes,
wherein the porous layer comprises particles bonded to each other by a metal or nonmetal oxide, the metal or nonmetal oxide deposited from a treatment solution comprising a deposition promoter and a complex comprising a metal or nonmetal ion and a ligand via reaction of the ligand with the deposition promoter.

2. A method of forming a porous layer in a display element comprising the porous layer and an electrolyte between a pair of facing electrodes, comprising the steps of:
placing particles on at least one of the pair of facing electrodes,
immersing the at least one of the pair of facing electrodes on which the particles are placed in a treatment solution comprising a deposition promoter and a complex comprising a metal or nonmetal ion and a ligand to deposit a metal or nonmetal oxide, and
bonding the particles to each other to form the porous layer.

3. The display element of claim 1,
wherein the electrolyte comprises a metal salt compound to conduct a black display and a white display via driving operation of the pair of facing electrodes.

4. The display element of claim 1, comprising a compound represented by the following Formula (L), provided between the pair of facing electrodes, to conduct a white display and a display other than the white display via driving operation of the pair of facing electrodes: 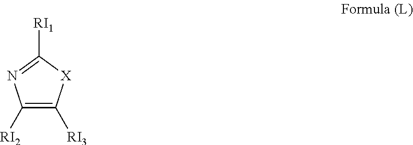
wherein Rl₁, represents a substituted or unsubstituted aryl group; each of Rl₂ and Rl₂ represents a hydrogen atom or a substituent;
and X represents >N-Rl₄, an oxygen atom or a sulfur atom, wherein Rl₄ represents a hydrogen atom or a substituent.

5. The display element of claim 3, comprising a compound represented by the Formula (L), provided between the pair of facing electrodes, to conduct a color display other than a black display and a white display in addition to the black display and the white display via driving operation of the pair of facing electrodes.

6. The display element of claim 3,
wherein the metal salt compound comprises a silver salt compound.

7. The display element of claim 1,
wherein the electrolyte comprises a compound represented by the following Formula (G-1) or Formula (G-2):
Rg₁₁-S-Rg₁₂ Formula (G-1)
wherein each of Rg₁₁ and Rg₁₂ represents a substituted or unsubstituted hydrocarbon group; the hydrocarbon group may contain at least one selected from the group consisting of a nitrogen atom, an oxygen atom, a sulfur atom, a sulfur atom and a halogen atom; and Rg₁₁ and Rg₁₂ may be connected to each other to form a cyclic structure, 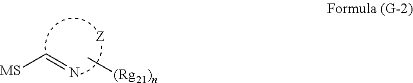
wherein M represents a hydrogen atom, a metal atom or a quaternary ammonium; Z represents an atomic group to constitute a nitrogen-containing heterocyclic ring; n is an integer of 0-5; and Rg₂₁ represents a substituent; and when n is 2 or more, Rg₂₁s each may be the same or different and may also be connected to each other to form a condensed ring.

8. The display element of claim 4,
wherein the compound represented by Formula (L) is chemically or physically adsorbed onto at least a porous electrode.

9. The display element of claim 8,
wherein the compound represented by Formula (L) comprises at least one substituent selected from the group consisting of —COOH, —P═O(OH)₂, —OP═O(OH)₂, and —Si(OR)₃ where R represents an alkyl group.

10. The display element of claim 1,
wherein the metal or nonmetal oxide deposited from a treatment solution comprises SiO₂ or TiO₂.

11. The display element of claim 1,
wherein the porous layer is electrically conductive.

12. The display element of claim 5,
wherein the metal salt compound comprises a silver salt compound.

13. The display element of claim 3,
wherein the electrolyte comprises a compound represented by the following Formula (G-1) or Formula (G-2):
Rg₁₁-S-Rg₁₂ Formula (G-1)
wherein each of Rg₁₁ and Rg₁₂ represents a substituted or unsubstituted hydrocarbon group; the hydrocarbon group may contain at least one selected from the group consisting of a nitrogen atom, an oxygen atom, a sulfur atom, a sulfur atom and a halogen atom; and Rg₁₁ and Rg₁₂ may be connected to each other to form a cyclic structure, 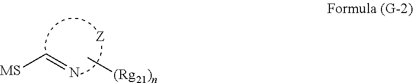
wherein M represents a hydrogen atom, a metal atom or a quaternary ammonium; Z represents an atomic group to constitute a nitrogen-containing heterocyclic ring; n is an integer of 0-5; and Rg₂₁ represents a substituent; and when n is 2 or more, Rg₂₁s each may be the same or different and may also be connected to each other to form a condensed ring.

14. The display element of claim 4,
wherein the electrolyte comprises a compound represented by the following Formula (G-1) or Formula (G-2):
Rg₁₁-S-Rg₁₂ Formula (G-1)
wherein each of Rg₁₁ and Rg₁₂ represents a substituted or unsubstituted hydrocarbon group; the hydrocarbon group may contain at least one selected from the group consisting of a nitrogen atom, an oxygen atom, a sulfur atom, a sulfur atom and a halogen atom; and Rg₁₁ and Rg₁₂ may be connected to each other to form a cyclic structure, 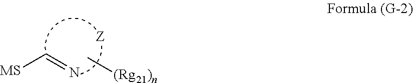
wherein M represents a hydrogen atom, a metal atom or a quaternary ammonium; Z represents an atomic group to constitute a nitrogen-containing heterocyclic ring; n is an integer of 0-5; and Rg₂₁ represents a substituent; and when n is 2 or more, Rg₂₁s each may be the same or different and may also be connected to each other to form a condensed ring.

15. The display element of claim 5,
wherein the electrolyte comprises a compound represented by the following Formula (G-1) or Formula (G-2):
Rg₁₁-S-Rg₁₂ Formula (G-1)
wherein each of Rg₁₁ and Rg₁₂ represents a substituted or unsubstituted hydrocarbon group; the hydrocarbon group may contain at least one selected from the group consisting of a nitrogen atom, an oxygen atom, a sulfur atom, a sulfur atom and a halogen atom; and Rg₁₁ and Rg₁₂ may be connected to each other to form a cyclic structure, 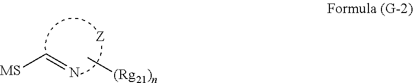
wherein M represents a hydrogen atom, a metal atom or a quaternary ammonium; Z represents an atomic group to constitute a nitrogen-containing heterocyclic ring; n is an integer of 0-5; and Rg₂₁ represents a substituent; and when n is 2 or more, Rg₂₁s each may be the same or different and may also be connected to each other to form a condensed ring.

16. The display element of claim 6,
wherein the electrolyte comprises a compound represented by the following Formula (G-1) or Formula (G-2):
Rg₁₁-S-Rg₁₂ Formula (G-1)
wherein each of Rg₁₁ and Rg₁₂ represents a substituted or unsubstituted hydrocarbon group; the hydrocarbon group may contain at least one selected from the group consisting of a nitrogen atom, an oxygen atom, a sulfur atom, a sulfur atom and a halogen atom; and Rg₁₁ and Rg₁₂ may be connected to each other to form a cyclic structure, 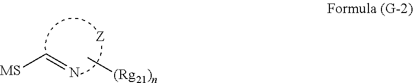
wherein M represents a hydrogen atom, a metal atom or a quaternary ammonium; Z represents an atomic group to constitute a nitrogen-containing heterocyclic ring; n is an integer of 0-5; and Rg₂₁ represents a substituent; and when n is 2 or more, Rg₂₁s each may be the same or different and may also be connected to each other to form a condensed ring.

17. The display element of claim 12,
wherein the electrolyte comprises a compound represented by the following Formula (G-1) or Formula (G-2):
Rg₁₁-S-Rg₁₂ Formula (G-1)
wherein each of Rg₁₁ and Rg₁₂ represents a substituted or unsubstituted hydrocarbon group; the hydrocarbon group may contain at least one selected from the group consisting of a nitrogen atom, an oxygen atom, a sulfur atom, a sulfur atom and a halogen atom; and Rg₁₁ and Rg₁₂ may be connected to each other to form a cyclic structure, 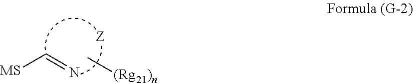
wherein M represents a hydrogen atom, a metal atom or a quaternary ammonium; Z represents an atomic group to constitute a nitrogen-containing heterocyclic ring; n is an integer of 0-5; and Rg₂₁ represents a substituent; and when n is 2 or more, Rg₂₁s each may be the same or different and may also be connected to each other to form a condensed ring.

18. The display element of claim 5,
wherein the compound represented by Formula (L) is chemically or physically adsorbed onto at least a porous electrode.

19. The display element of claim 5,
wherein the compound represented by Formula (L) comprises at least one substituent selected from the group consisting of —COOH, —P═O(OH)₂, —OP═O(OH)₂, and —Si(OR)₃ where R represents an alkyl group.

20. The display element of claim 3,
wherein the metal or nonmetal oxide deposited from a treatment solution comprises SiO₂ or TiO₂.
